(19) United States
(12) Patent Application Publication
(10) Pub. No.: US 2026/0363931 A1
(43) Pub. Date: Nov. 19, 2026

(54) LIFTING DEVICE FOR BEDSIDE ASSISTANCE

(71) Applicant: Alexander James Norred, Anaheim, CA (US)

(72) Inventor: Alexander James Norred, Anaheim, CA (US)

(21) Appl. No.: 19/680,598

(22) Filed: May 18, 2026

Related U.S. Application Data
(60) Provisional application No. 63/807,796, filed on May 18, 2025.

(51) Int. Cl. A61G 7/10

(52) U.S. Cl. CPC A61G 7/1096; A61G 7/1017; A61G 7/1019; A61G 7/1057

(57) ABSTRACT

A leg lifting device may include a leg support and an actuator support coupled to the leg support. The device may include a support member extending transverse to a longitudinal axis of a mattress of a bed, the actuator support being coupled to the support member. The device may include one or more engagement members coupled to the support member and configured to couple the lifting device to the bed. The leg support, actuator support, and support member can support one or more legs of the patient over the bed. The actuator support can move in a first direction to transition the lifting device from a stowed position to a deployed position and a second direction opposite the first direction to transition the lifting device from the deployed position to the stowed position. The leg support can be spaced at higher elevation in the deployed position.

### CROSS REFERENCE TO RELATED APPLICATIONS

This application claims the priority benefit of U.S. Provisional Application No. 63/807,796, filed May 18, 2025, which is hereby incorporated by reference in its entirety. All applications for which a foreign or domestic priority is identified in the Application Data Sheet as filed with the present application are hereby incorporated by reference under 37 CFR 1.57.

### FIELD

This disclosure relates to a lifting device for bedside assistance, and more particularly to a leg and/or lower body lifting device to assist in changing diapers of a bedridden patient.

### BACKGROUND

Bedside care for an immobilized or limited-mobility patient may involve a caregiver regularly repositioning the patient to change the patient's clothing (e.g., underwear, diaper) and clean the patient in order to maintain patient hygiene. The caregiver may need to maintain the patient in a suitable position during such tasks. For example, the caregiver may need to raise one or both of the patient's legs and/or the patient's lower body in order to change the patient's clothes and clean the patient.

### SUMMARY

Repeatedly repositioning a patient in order to administer bedside care (e.g., changing and/or cleaning) can be physically demanding for caregivers, particularly when a patient is heavy, unable to assist with movement, or sensitive to repositioning. Repeated or awkward patient repositioning by the caregiver may contribute to caregiver strain and/or may affect patient hygiene.

The leg lifting devices disclosed herein can address one or more of the foregoing issues and others. The leg lifting devices can raise the patient's legs and/or lower body (e.g., torso) above the bed in order to provide a caregiver with easier access to the patient for changing and cleaning. The leg lifting devices can be coupled to existing beds (e.g., hospital beds) to increase ease of use and compatibility with existing caregiving facility infrastructure. The leg lifting devices can be transitioned between a plurality of positions (e.g., configurations). For example, the leg lifting devices can be transitioned to a stowed position when not in use to decrease a footprint of the leg lifting device and/or allow easier access into and out of the bed. The leg lifting device can be transitioned to a deployed position in use to raise the legs and/or lower body of a patient above the bed. The leg lifting device may be transitioned between a retracted position and an extended position, for example, when deployed, to adjust a height of the patient's legs.

In some aspects, a lifting device for raising legs of a patient is disclosed herein. The lifting device can include a leg support. The lifting device can include an actuator support coupled to the leg support at a first end of the leg support, a second end of the leg support being disposed opposite the first end. The lifting device can include a support member configured to extend transverse to a longitudinal axis of a mattress of a bed, the actuator support being coupled to the support member. The lifting device can include one or more engagement members coupled to the support member, the one or more engagement members configured to couple to a bed to couple the lifting device to the bed. The leg support, the actuator support, and the support member can form a structure configured to support one or more legs of the patient over the bed. The actuator support can be movable in a first direction to transition the lifting device from a stowed position to a deployed position. The actuator support can be movable in a second direction opposite the first direction to transition the lifting device from the deployed position to the stowed position. The leg support can be spaced at higher elevation above the bed in the deployed position.

In some aspects, the second end of the leg support is a free end and the leg support, the actuator support, and the support member form a C-shaped structure.

In some aspects, the lifting device is configured to be removably coupled to a bed frame of the bed.

In some aspects, the lifting device includes a first clamp disposed at a first end of the support member, the first clamp configured to removably couple to the bed frame.

In some aspects, the lifting device includes a second clamp disposed at a second end of the support member opposite the first end, the first and second clamps configured to removably couple to opposite sides of the bed frame.

In some aspects, the first clamp includes a clamp frame and a movable jaw configured to clamp a portion of the bed frame between the clamp frame and the movable jaw, wherein the movable jaw is repositionable relative to the clamp frame to adjust a position of the movable jaw relative to the bed frame.

In some aspects, the lifting device includes a linear actuator configured to move the leg support between a retracted position and an extended position, wherein a height of the leg support in the extended position is greater than a height of the leg support in the retracted position.

In some aspects, the actuator support is pivotably coupled to the support member, the actuator support configured to pivot between the stowed position and the deployed position.

In some aspects, the lifting device includes a pivot stop configured to couple to a frame of the bed to limit pivotable movement of the actuator support in the first direction.

In some aspects, the pivot stop is configured to prevent pivotable movement of the actuator support beyond thirty degrees relative to vertical.

In some aspects, a bed support system for a lifting device is disclosed herein. The lifting device can include a support member including an elongate body have a first end configured to be disposed on a first side of a bed and a second end configured to be disposed on a second side of the bed opposite to the first side of the bed. The lifting device can include a first bed engagement member having a first portion configured to couple with a bed on the first side of the bed and a second portion configured to couple with the first end of the support member. The lifting device can include a second bed engagement member having a first portion configured to couple with a bed on the second side of the bed and a second portion configured to couple with the second end of the support member. The lifting device can include an angle control structure coupled with the first bed engagement member, the angle control structure configured to limit movement of an actuator support to define one or more of a position and an angle of a leg support beam relative to vertical.

In some aspects, the angle control structure includes a plate member having an upright planar portion configured to be inclined at an angle between 5 and 30 degrees from vertical when the bed support system is mounted to the bed.

In some aspects, a lifting device is disclosed herein including: the bed support system; an actuator support pivotably coupled with the first bed engagement member adjacent to a first end and extending away from the first end to a second end; and a leg support beam having a first end coupled with the second end of the actuator support and a second end opposite to the first end; wherein a first contact surface of the actuator support is supported by the plate member when the actuator support is in a deployed position.

In some aspects, the leg support beam is cantilevered by the actuator support such that the leg support beam has a free end and an unobstructed access path to or from the bed is provided under the leg support beam when the actuator support is in the deployed position.

In some aspects, the lifting device includes a linear actuator coupled with the actuator support to drive the leg support beam between an elevated position and a lowered position.

In some aspects, one or both of the first bed engagement member and the second bed engagement member includes a clamp including a fixed jaw and a movable jaw, the movable jaw being translatable relative to the fixed jaw to allow clamping over a length, a width, or a height of the bed.

In some aspects, the movable jaw is supported in a slotted plate disposed opposite to the fixed jaw.

In some aspects, ] a lifting device for raising legs of a patient is disclosed herein. The lifting device can include one or more leg supports for receiving the legs of a patient. The lifting device can include an actuator support pivotably coupled to the one or more leg supports. The lifting device can include a support member configured to extend transverse to a longitudinal axis of a mattress of a bed, the actuator support being movably coupled to the support member. The lifting device can include one or more engagement members coupled to the support member, the one or more engagement members configured to couple to a bed to couple the lifting device to the bed. The one or more leg supports, the actuator support, and the support member can form a structure configured to support one or more legs of the patient over the bed. The one or more leg supports can pivot toward the actuator support to transition the lifting device to a stowed position. The one or more leg supports can pivot away from the actuator support to transition the lifting device to a deployed position. The one or more leg supports are positioned over the bed in the deployed position and a footprint of the lifting device is smaller in the stowed position than in the deployed position.

In some aspects, the one or more leg supports include a first leg support and a second leg support, the first and second leg supports coupled to separate arms configured to suspend the first and second leg supports over the bed when in the deployed position.

In some aspects, the arms are configured to pivot about multiple axes, the leg supports configured to pivot with the respective arm.

For purposes of this summary, certain aspects, advantages, and novel features are described herein. It is to be understood that not necessarily all such advantages may be achieved in accordance with any particular aspect. Thus, for example, those skilled in the art will recognize the disclosures herein may be carried out in a manner that achieves one or more advantages taught herein without necessarily achieving other advantages as may be taught or suggested herein.

### BRIEF DESCRIPTION OF THE DRAWINGS

The abovementioned and other features of the embodiments disclosed herein are described below with reference to the drawings of the embodiments. The illustrated embodiments are intended to illustrate, but not to limit, the scope of protection. Various features of the different disclosed embodiments can be combined to form further embodiments, which are part of this disclosure.

FIG. 1A illustrates a perspective view of a leg lifting device in a stowed position coupled to a bed.

FIG. 1B illustrates a perspective view of the leg lifting device of FIG. 1A in a deployed position coupled to the bed with a leg support in a retracted position.

FIG. 1C illustrates a perspective view of the leg lifting device of FIG. 1A in a deployed position coupled to the bed with the leg support in an extended position.

FIG. 2A illustrates a perspective view of the leg lifting device of FIG. 1A in the deployed position with the leg support in the extended position.

FIG. 2B illustrates a perspective view of the leg lifting device of FIG. 1A with portions of an actuator housing removed.

FIG. 2C illustrates a side view of the leg lifting device of FIG. 1A with portions of the actuator housing removed.

FIG. 2D illustrates a front view of the leg lifting device of FIG. 1A.

FIG. 2E illustrates a rear view of the leg lifting device of FIG. 1A.

FIG. 2F illustrates a top view of the leg lifting device of FIG. 1A.

FIG. 2G illustrates a bottom view of the leg lifting device of FIG. 1A.

FIG. 2H illustrates a side perspective view of an engagement assembly of the leg lifting device of FIG. 1A.

FIG. 2I illustrates a rear perspective view of the engagement assembly of FIG. 2H engaging with a bed frame of the bed.

FIG. 2J illustrates a side view of an actuator support of the leg lifting device of FIG. 1A engaging with a pivot stop.

FIG. 3 illustrates a perspective view of a leg lifting device in deployed position coupled to a bed with a leg support in a retracted position.

FIG. 4A illustrates a perspective view of the leg lifting device of FIG. 3 in the deployed position with the leg support in the extended position.

FIG. 4B illustrates a side view of the leg lifting device of FIG. 3.

FIG. 4C illustrates a front view of the leg lifting device of FIG. 3.

FIG. 4D illustrates a first side perspective view of an engagement assembly of the leg lifting device of FIG. 3.

FIG. 4E illustrates a second side perspective view of the engagement assembly of the leg lifting device of FIG. 3.

FIG. 4F illustrates a front perspective view of the engagement assembly of the leg lifting device of FIG. 3 engaging with a bed frame of the bed.

FIG. 5 illustrates the leg lifting device of FIG. 3 in a stowed position including a deployment actuator.

FIG. 6 illustrates a perspective view of an engagement assembly of a leg lifting device engaging with a bed frame of a bed.

FIG. 7A illustrates a perspective view of a leg lifting device in a stowed position coupled to a bed.

FIG. 7B illustrates a perspective view of the leg lifting device of FIG. 7A in a deployed position coupled to the bed with leg supports in a retracted position.

FIG. 7C illustrates a perspective view of the leg lifting device of FIG. 7A in a deployed position coupled to the bed with the leg supports in an extended position.

FIG. 8A illustrates a perspective view of the leg lifting device of FIG. 7A in the stowed position.

FIG. 8B illustrates a perspective view of the leg lifting device of FIG. 7A in the deployed position with the leg supports in the retracted position.

FIG. 8C illustrates a perspective view of the leg lifting device of FIG. 7A in the deployed position with the leg supports in the extended position.

FIG. 9 illustrates a perspective view of an engagement assembly of a leg lifting device including a position retention mechanism.

FIG. 10A illustrates a perspective view of a portion of a leg lifting device in a stowed position including a position retention mechanism.

FIG. 10B illustrates a perspective view of a portion of the leg lifting device of FIG. 10A in a deployed position including the position retention mechanism.

FIG. 11 illustrates a perspective view of an engagement assembly for coupling a leg lifting device to a bed.

FIG. 12 illustrates a support structure for use with a leg lifting device.

FIG. 13 illustrates a perspective view of an engagement assembly and support member for use with a leg lifting device.

FIG. 14A illustrates a side view of a leg lifting device.

FIG. 14B illustrates a side view of an actuator base of the lifting device of FIG. 14A

FIG. 14C illustrates a perspective view of the leg lifting device of FIG. 14A.

FIG. 15 illustrates a leg support beam of the leg lifting device of FIG. 14A.

FIG. 16 illustrates a side view of portions of the leg lifting device of FIG. 14A.

FIG. 17A illustrates a top view of a frame engagement member of a leg lifting device.

FIG. 17B illustrates a front view of a tightening mechanism of a leg lifting device.

FIG. 17C illustrates a front view of a gripping jaw of a leg lifting device.

FIG. 18A illustrates a perspective view of a leg lifting device.

FIG. 18B illustrates a cross-sectional view of a motor box of the leg lifting device of FIG. 18A.

FIG. 19A illustrates a perspective view of a leg lifting device.

FIG. 19B illustrates a cross-sectional view of a linear bearing of the leg lifting device of FIG. 19A.

FIG. 19C illustrates a roller bearing mechanism of the leg lifting device of FIG. 19A.

FIG. 20 illustrates a perspective view of a leg support hoist.

FIG. 21 illustrates a front view of a leg support hoist.

### DETAILED DESCRIPTION

Although several aspects, examples, and illustrations are disclosed below, it will be understood by those of ordinary skill in the art that the system, methods, and devices described herein extend beyond the specifically disclosed aspects, examples, and illustrations and includes other uses of the system, methods, and devices and obvious modifications and equivalents thereof. The terminology used in the description presented herein is not intended to be interpreted in any limited or restrictive manner simply because it is being used in conjunction with a detailed description of certain specific aspects of the disclosure. In addition, aspects of the disclosure can comprise several novel features and no single feature is solely responsible for its desirable attributes or is essential to practicing the system, methods, and devices herein described.

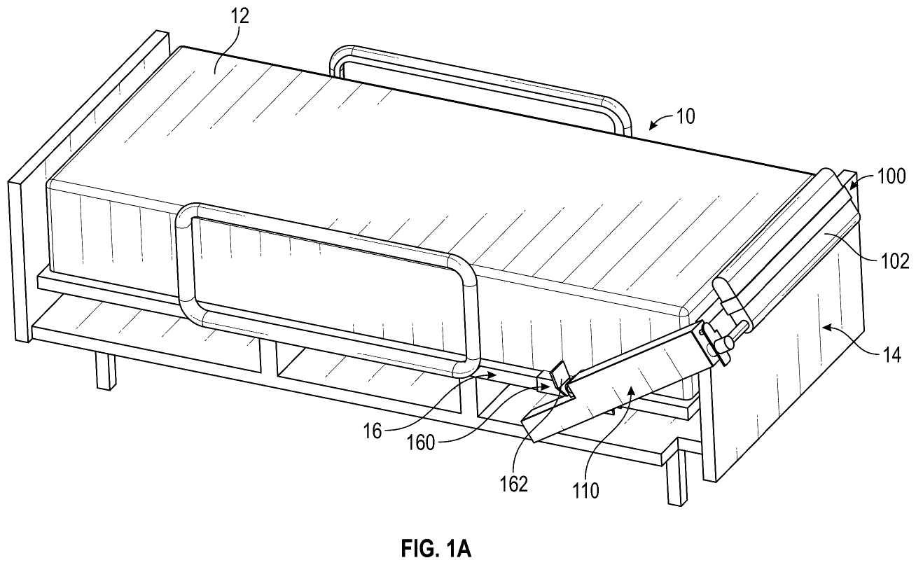

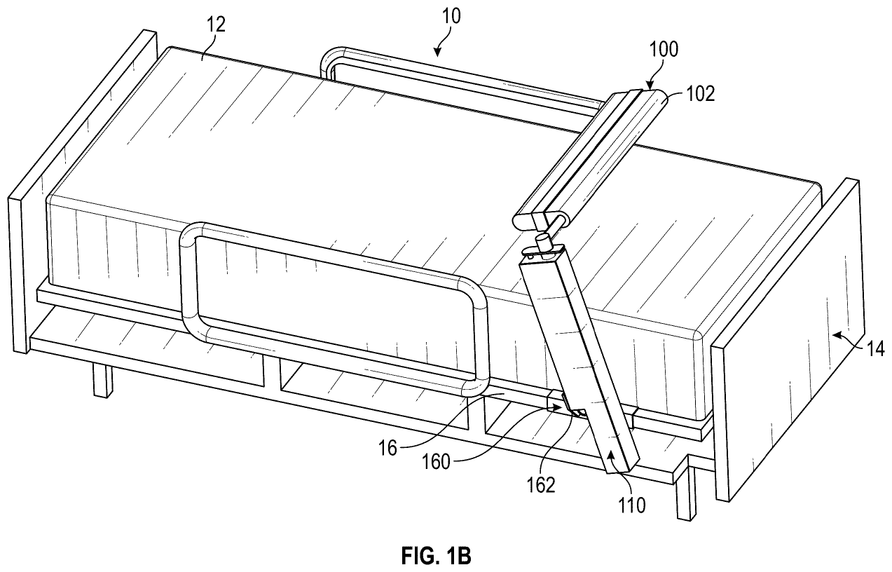

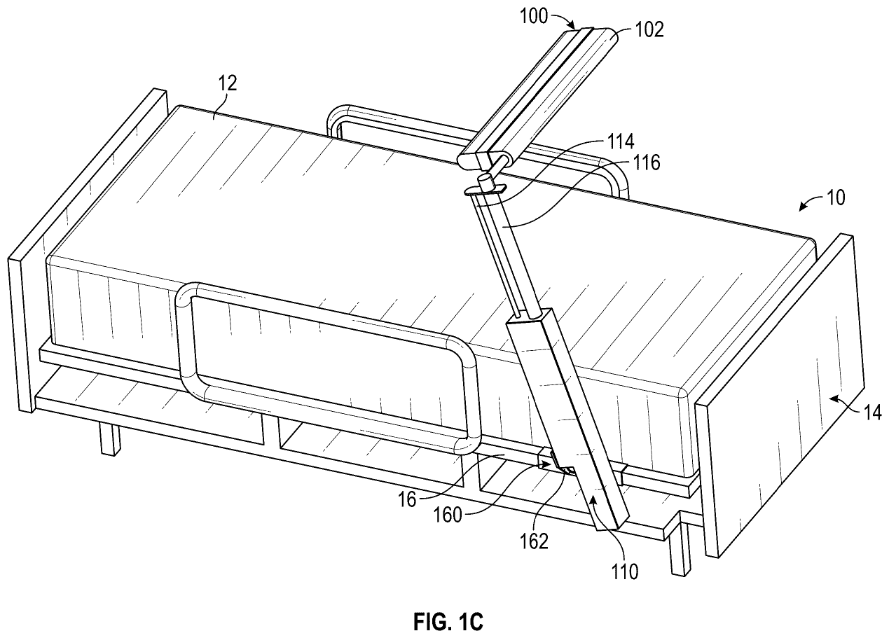

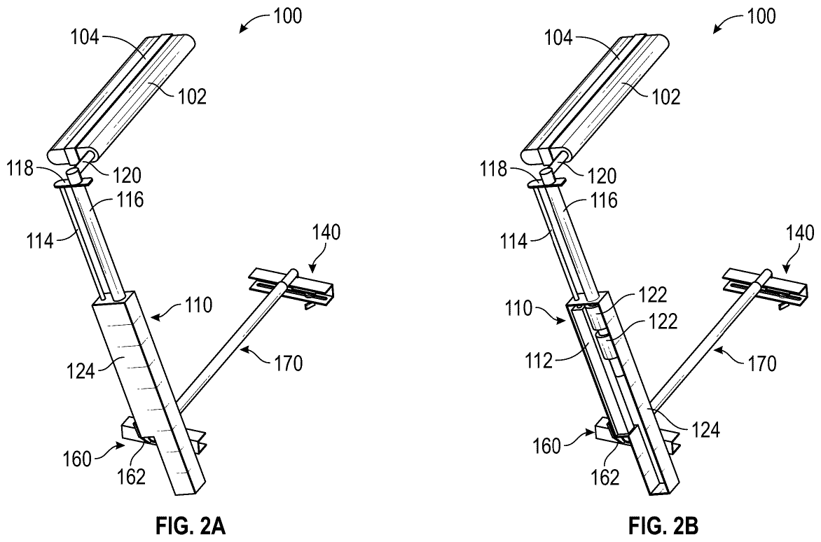

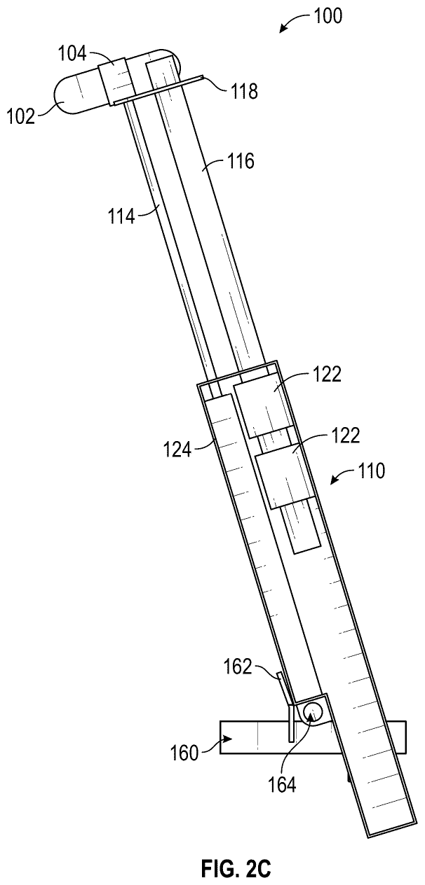

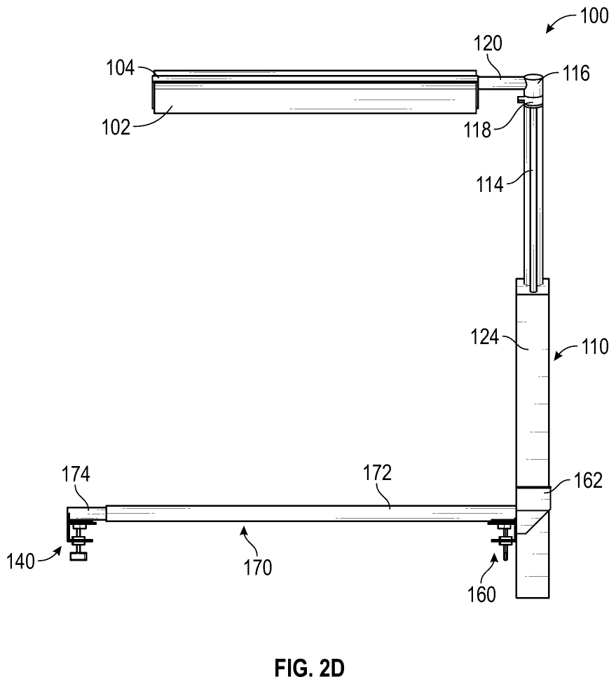

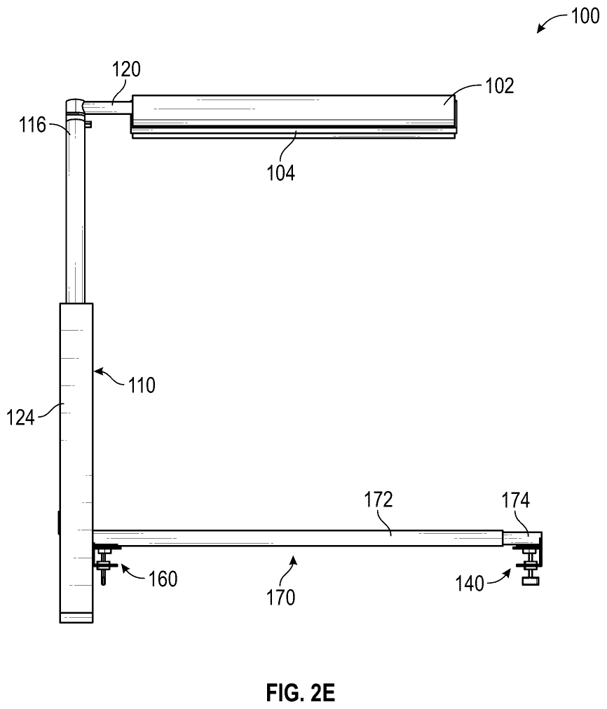

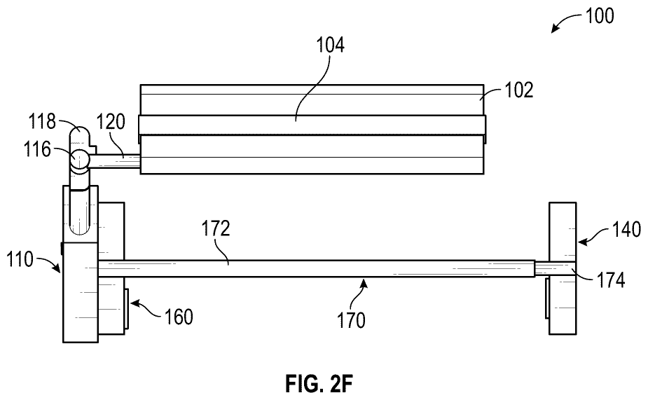

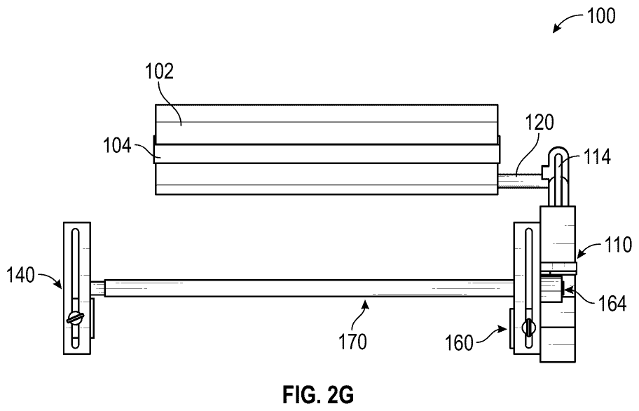

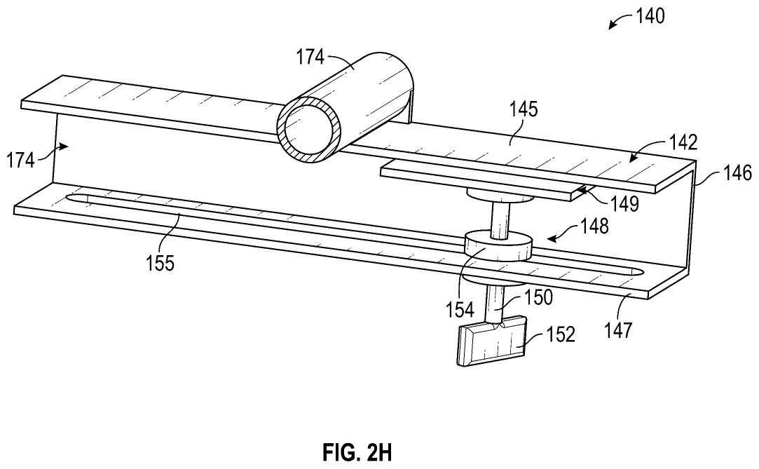

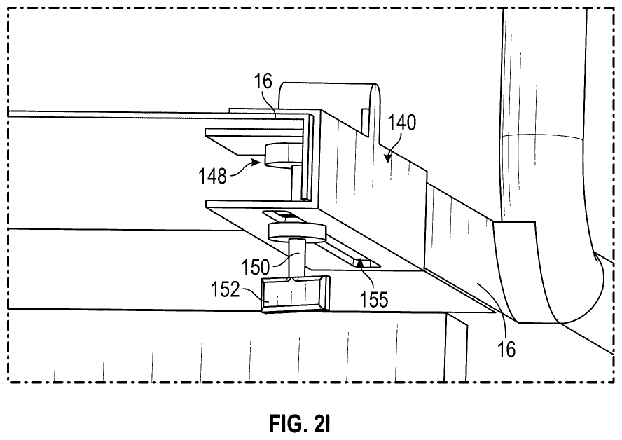

FIGS. 1A-2J illustrate various views of a leg lifting device 100 (which may also be referred to herein as a lifting device) and components thereof. As shown in FIGS. 1A-1C, the lifting device 100 can (e.g., removably) couple to a bed 10 (e.g., a bed frame 16) which may allow the lifting device 100 to be utilized with existing caregiving facility infrastructure. The lifting device 100 can lift one or both legs of a patient above the bed 10 (e.g., above a mattress 12 of the bed 10) which may allow a caregiver to change and/or clean the patient. For example, lifting the patient's legs may allow a caregiver to more easily change the clothes and/or diapers of immobile or limited mobility patients. In some aspects, the lifting device 100 can lift at least a portion of the patient's torso (e.g., the lower torso including the pelvis and/or abdomen) above the bed 10, which may improve caregiver access to the patient. For example, the lifting device 100 may lift the patient's legs to a height that also lifts the patient's pelvis. The lifting device 100 can include a leg support 102 (e.g., a leg support beam), an actuator support 110 (which may also be referred to herein as a load member), one or more engagement assemblies 140, 160 (which may also be referred to herein as engagement members, couplers, or clamping assemblies), and/or a support member 170.

The actuator support 110 may include a structural support member configured to transfer loads, moments, and/or torque between the leg support 102 and the support member 170 and/or the engagement assemblies 140, 160. In some aspects, an actuation source, such as a linear actuator, motor, winch, hydraulic actuator, pneumatic actuator, spring-assisted mechanism, or other drive mechanism, may be mechanically distinct from and coupled to the actuator support 110 such that the actuator support 110 provides structural support while the actuation source provides movement. In other aspects, the actuator support 110 and the actuation source may be integrated into a common structure. For example, the actuator support 110 may include an actuator having sufficient rigidity and torque resistance, such as a reinforced linear actuator, boom arm actuator, or other load-bearing actuator structure. In some aspects, the actuator support 110 may include multiple interconnected structural members to support movement of the leg support 102 relative to the support member 170. In one aspect, the actuator support 110 can include a plurality of links arranged in a diamond or X-pattern that can be driven to elevate a top portion of the actuator support 110 to elevate the leg supports 102 coupled with the top portion. The actuator support 110 can be configured as a scissor jack. In some aspects, the actuator support 110 may remain substantially fixed relative to the support member 170 while one or more leg supports 102 move relative to the actuator support 110 and/or the support member 170. The leg support 102 may include one or more rigid, semi-rigid, or flexible support structures configured to support one or more portions of a patient's legs. For example, the leg support 102 may include beams, frames, cushions, slings, harnesses, straps, hammocks, platforms, cradles, or combinations thereof.

The lifting device 100 (e.g., the actuator support 110) can be transitioned (e.g., moved, pivoted) between a stowed position (as shown, for example, in FIG. 1A) and a deployed position (as shown, for example, in FIGS. 1B & 1C). The lifting device 100 can be transitioned to the stowed position when not in use, for example, when a caregiver is not changing or cleaning the patient. When in the stowed position, a footprint of the lifting device 100, or in general the components of the device 100 over or around the patient, can be reduced. In some aspects, the leg support 102 and/or the actuator support 110 can be positioned proximate (e.g., closer to) a foot (e.g., footboard) 14 of the bed 10. For example, the leg support 102 can be positioned above or distal to the footboard 14 of the bed 10 when in the stowed position. In some aspects, a majority or entirety of the actuator support 110 can be positioned below a top (e.g., top plane) of the mattress 12 when in the stowed position. In some cases, the support 102 can be positioned such that the foot end of the bed is longitudinally between the support and the mattress of the bed. Positioning the lifting device 100 closer to or beyond the footboard 14 of the bed 10 and/or below a top plane of the mattress 12 in the stowed position may improve access to the bed 10 and/or patient, for example, when performing other tasks and/or moving the patient into and/or out of the bed 10. In some aspects, the leg support 102 can move adjacent a (e.g., lateral) side of the bed when in the stowed position.

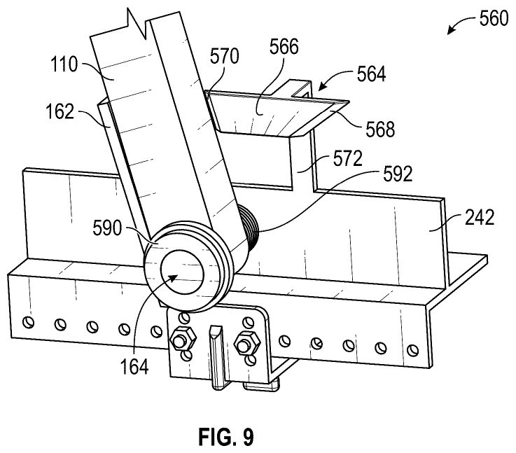

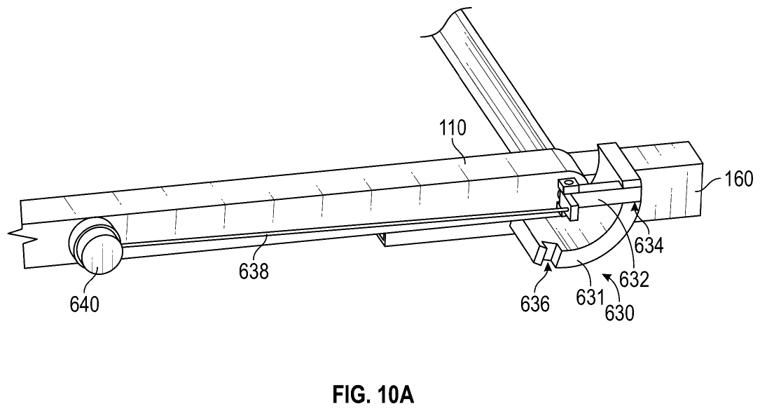

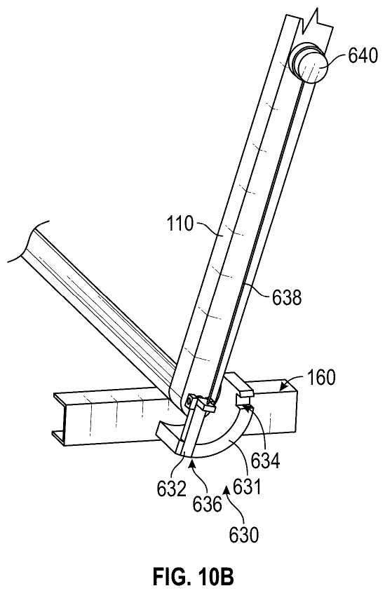

The lifting device 100 can be transitioned to the deployed position when in use, for example, when a caregiver needs to change or clean the patient. The leg support 102 can be positioned at a higher elevation (e.g., height) above the bed 10 (e.g., the mattress 12) when in the deployed position compared to the stowed position (for example, as shown in FIG. 1B). When in the deployed position, the leg support 102 can be positioned above the mattress 12 (e.g., above a distal portion of the mattress 12). A patient's leg(s) can be supported by (e.g., positioned on, secured to) the leg support 102 when in the deployed position to raise the patient's legs and/or lower body above the mattress 12. In some aspects, the lifting device 100 (e.g., the actuator support 110) can be selectively maintained in the stowed and/or deployed positions by one more positions retention mechanisms such as triggers, detents, pins, latches, cam locks, and/or other releasable retention mechanisms to inhibit or prevent inadvertent transitioning between the stowed and deployed positions (for example, as described with respect to FIGS. 9, 10A, & 10B). The lifting device 100 may selectively lock at one or more stowed, deployed, or intermediate positions between the stowed and deployed positions.

The lifting device 100 can be transitioned between the deployed and stowed positions by moving (e.g., pivoting) the actuator support 110 and/or the leg support 102. For example, the actuator support 110 can be moved in a first direction (e.g., toward a head of the bed 10 and/or upward) to transition the lifting device 100 from the stowed position to the deployed position and a second, opposite direction (e.g., toward the footboard 14 of the bed 10 and/or downward) to transition the lifting device 100 from the deployed position to the stowed position. In some aspects, the actuator support 110 can be pivoted between the stowed and deployed positions. For example, the actuator support 110 can be pivoted in a first direction (e.g., counterclockwise in the view of FIGS. 1A-1C) to transition the lifting device 100 from the stowed position to the deployed position and a second, opposite direction (e.g., clockwise in the view of FIGS. 1A-1C) to transition the lifting device 100 from the deployed position to the stowed position. The actuator support 110 can pivot about pivot (e.g., joint) 164 between the stowed and deployed positions (see, for example, FIG. 2C). The pivot 164 can define a pivot axis of the actuator support 110. In some aspects, a pivot axis of the actuator support 110 can correspond to the support member 170 (e.g., a longitudinal axis of the support member 170). The pivot axis of the actuator support 110 can be transverse to a longitudinal axis of the bed 10 and/or mattress 12. This may allow the leg support 102 to move longitudinally and vertically relative to the mattress 12 as the lifting device 100 transitions between the stowed and deployed positions (e.g., as the actuator support 110 pivots about the pivot 164). Movement between positions (e.g., stowed and deployed positions) may be assisted by springs, dampers, counterbalances, actuators, or energy-storage mechanisms. Movement between positions may be guided by slots, tracks, cams, rails, curved guide paths, bearings, or combinations thereof. Guided motion paths may provide a curved or anatomically compatible lifting trajectory for patient comfort.

In some aspects, the maximum movement (e.g., pivotable movement) of the actuator support 110 in the first and/or second direction can be limited by a stop (e.g., pivot stop) 162. The stop 162 (e.g., the shape and/or angle of the stop 162) can control an angle of the actuator support 110 (e.g., relative to vertical) when in the stowed and/or deployed positions. For example, as shown in FIGS. 1B & 2J, the actuator support 110 can be angled relative to vertical (e.g., toward a proximal end or head of the bed 10) when in the deployed position which may improve the stability and/or load bearing capability of the actuator support 110 when in the deployed position. As shown in FIG. 1A, the actuator support 110 can be angled (e.g., toward a distal end or footboard 14 of the bed 10) when in the stowed position. For example, the actuator support 110 may be angled above horizontal or substantially horizontal when in the stowed position. The stop 162 is further described with respect to FIG. 2J.

In some aspects, the lifting device 100 (e.g., the leg support 102) can be transitioned between a retracted position (as shown, for example, in FIGS. 1A & 1B) and an extended position (as shown, for example, in FIG. 1C) to adjust a height of the patient's legs and/or lower body. In some aspects, the lifting device 100 (e.g., the leg support 102) can remain in the retracted position when the lifting device 100 is transitioning (e.g., pivoting) between the stowed and deployed positions which may increase the stability of the lifting device 100 and/or decrease the risk of breakage. Once in the deployed position, a patient's legs can be positioned on (e.g., secured to) the leg support 102 by a caregiver. The patient's legs can be positioned on the leg support 102 while the leg support 102 is in the retracted position, which may require less caregiver effort and/or strength due to the lowered position of the leg support 102. The lifting device 100 (e.g., the leg support 102) can then be transitioned to the extended position to raise the leg support 102, thereby raising the patient's legs. Transitioning the lifting device 100 to the extended position may raise the patient's lower body (e.g., abdomen and/or pelvis) above the mattress 12.

The lifting device 100 can be transitioned between the retracted and extended positions via one or more actuators of the actuator support 110. In some aspects, the leg support 102 can move (e.g., translate) linearly relative to the actuator support 110 when transitioning between the retracted and extended positions. The leg support 102 can move vertically when transitioned between the retracted and extended positions. In some aspects, the leg support 102 can also move horizontally when transitioned between the retracted and extended positions. For example, when the lifting device 100 is in the deployed position and the leg support 102 is transitioned to the extended position, the leg support 102 can move vertically (e.g., upward) and horizontally (e.g., toward a head of the bed 10). The direction of translation of the leg support 102 when transitioning between the retracted and extended positions can be determined by the angle of the actuator support 110 (e.g., when in the deployed position). Moving the leg support 102 (and thus the patient's legs) toward the head of the bed 10 when transitioning toward the extended position may help raise the patient's lower body (e.g., pelvis).

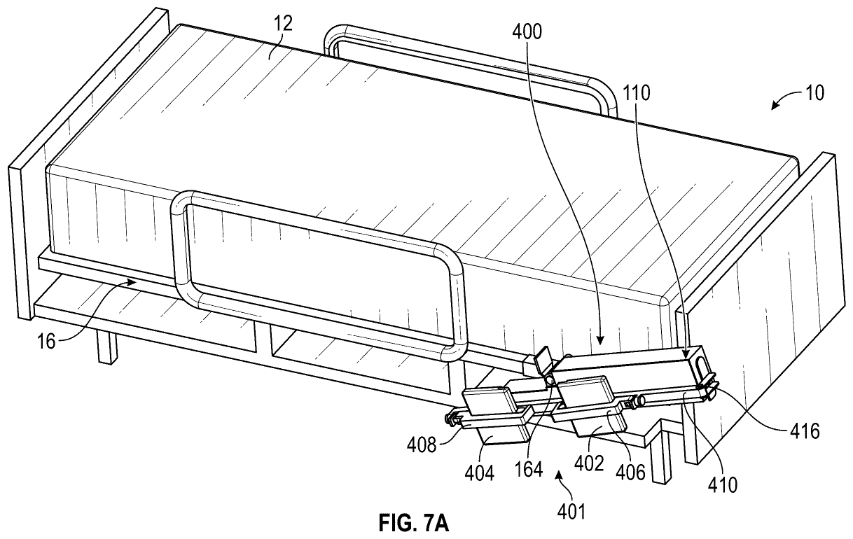

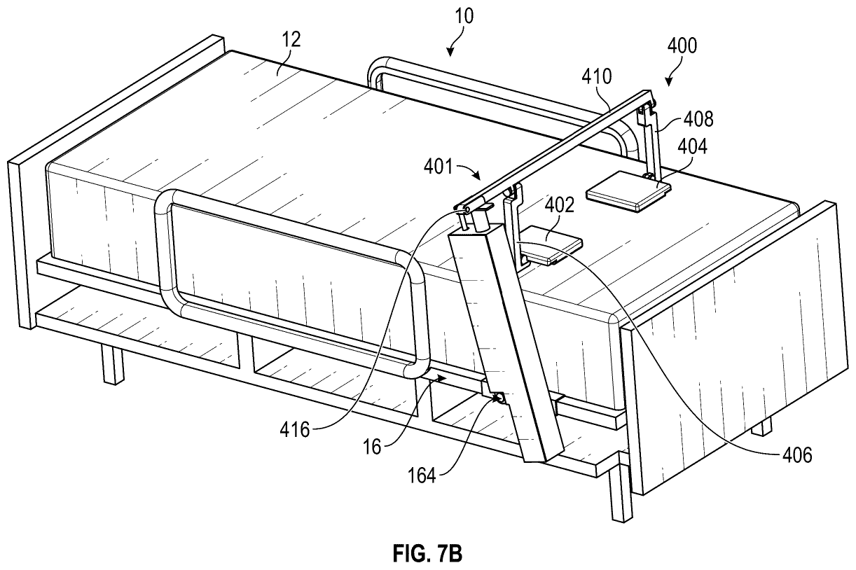

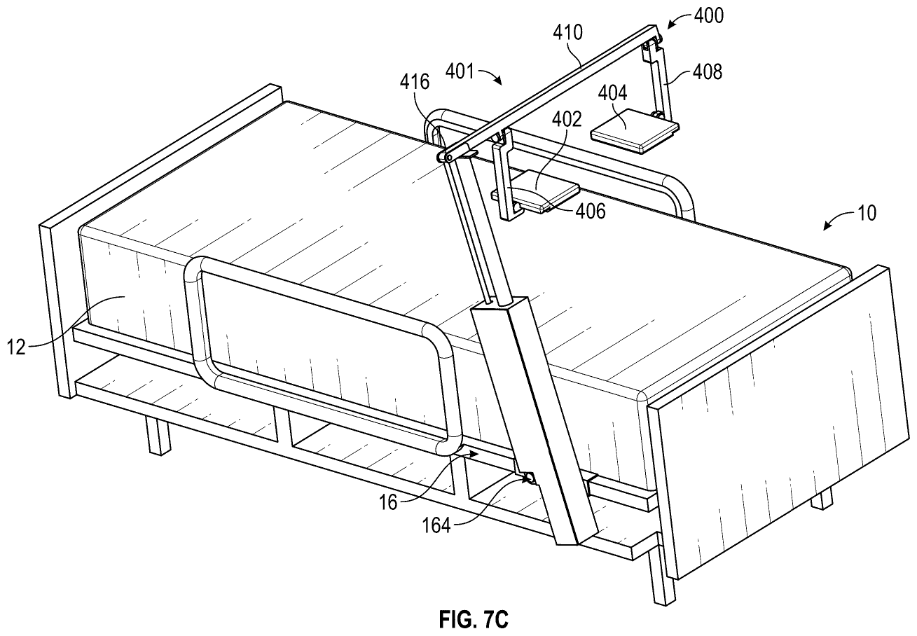

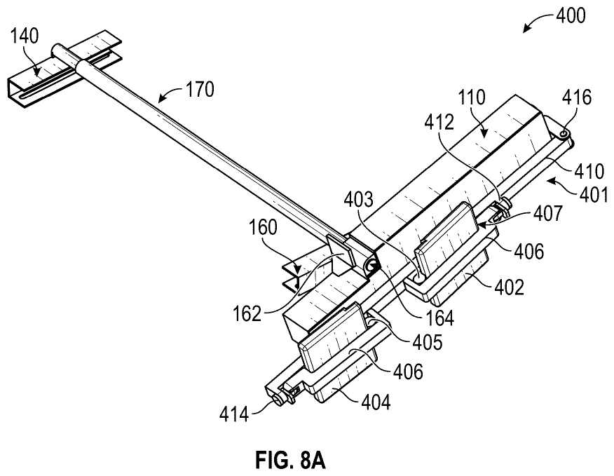

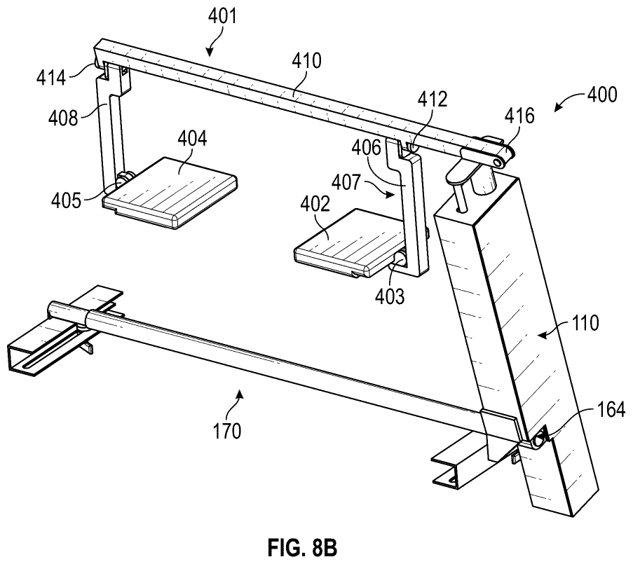

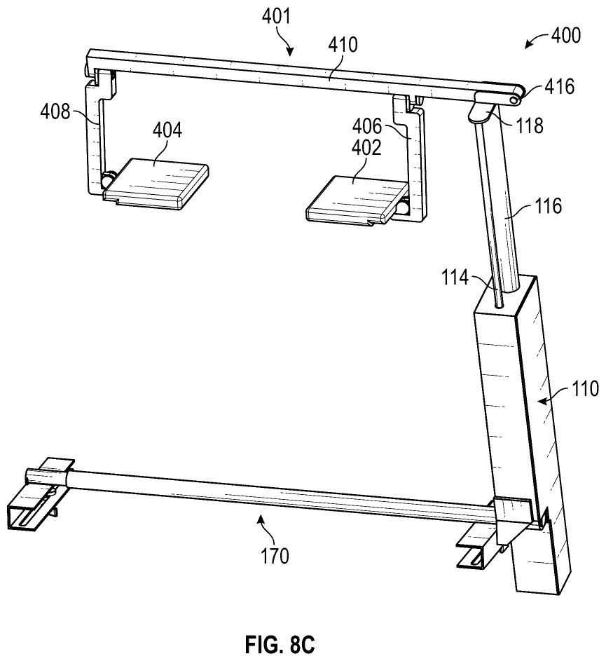

Turning to FIGS. 2A-2J, the leg support 102 (which may also be referred to herein as a leg support beam) can support one or both legs of the patient. For example, one or both legs of the patient can rest on the leg support 102. The leg support 102 can extend transverse to a longitudinal axis of the bed 10, for example, in a direction of the width of the bed 10. In some aspects, the leg support 102 (e.g., when in the deployed position) can be positioned at or proximate (e.g., a rear side of) the patient's knees such that the patient's lower legs (e.g., calves) are positioned on top of the leg support 102. The leg support 102 can include one or more beams, harnesses, straps, slings, or any other appropriate mechanism for supporting the patient's legs. In some aspects, the lifting device 100 can include a single leg support 102 which can support both the patient's legs. In other aspects, the lifting device 100 can include two leg supports 102 (for example, as shown in FIGS. 7A-8C) which can individually support the patient's legs. Any leg support described herein may pivot, articulate, swing, rotate, or otherwise move relative to the support structure 170. For example, elongated cushions, pillows, or support members of the leg support 102 may articulate or sway to accommodate patient anatomy.

The leg support 102 can include one or more straps 104 for removably securing the patient's leg(s) to the leg support 102. The patient's leg(s) can be positioned between the leg support 102 and the strap(s) 104 when the lifting device 100 is in use. The straps 104 can assist in keeping the patient's legs stationary which may increase the ease with which a caregiver can perform their tasks. In some aspects, the leg support 102 can include a single strap 104 for both legs. In other aspects, the leg support 102 can include separate straps 104 for each leg. The straps 104 can be formed at least partially of an elastic material. In some aspects, the straps 104 can include a cinching mechanism (e.g., a buckle) to assist in securing the patient's legs to the leg support 102. The leg support 102 may transition between a leg support configuration (e.g., in which the leg support 102 contacts one or both of the patient's legs or calves) and a foot support configuration (e.g., in which the leg support 102 contacts one or both of the patient's feet).

The leg support 102 can couple (e.g., directly or indirectly) to the actuator support 110, for example, at or proximate a first (e.g., lateral) end of the leg support 102. In some aspects, the leg support 102 can couple to the actuator support 110 via a link (e.g., rod, beam) 120. The link 120 can extend from the first end of the leg support 102. In some aspects, a second, opposite end of the leg support 102 can be free (e.g., uncoupled). For example, the actuator support 110 and the leg support 102 can form a cantilever structure. Leaving the second end of the leg support 102 free may allow a caregiver to more easily access the patient on the corresponding side of the bed 10. For example, access to the patient and/or bed 10 at the side of the bed 10 corresponding to the free end of the leg support 102 can be partially or substantially unobstructed. In some aspects, the leg support 102 can removably couple to the actuator support 110. For example, the lifting device 100 can include a safety release to decouple the leg support 102 from the actuator support 110 in order to disengage the patient from the lifting device 100 (e.g., in the case of failure of an actuator).

The actuator support 110 can include an actuator 112, a first elongate member 114, and/or a second elongate member 116. The actuator 112 can include a linear actuator which can linearly displace (e.g., extend and retract) the first elongate member 114 (which may also be referred to herein as a driven rod). In some aspects, the actuator 112 can include one or more (e.g., electric) motors and/or one more hydraulic, pneumatic, piezoelectric, or magnetic actuator systems for generating linear motion. In other aspects, the actuator 112 can be manually driven, for example, via a winch or hand crank. The actuator 112 can transition (e.g., translate) the first elongate member 114 between an extended (e.g., raised) position and a retracted (e.g., lowered) position.

The actuator 112 can be operatively coupled to the leg support 102 such that the actuator 112 can transition (e.g., translate) the leg support 102 between the retracted (e.g., lowered) position (as shown, for example, in FIG. 1B) and the extended (e.g., raised) position (as shown, for example, in FIG. 1C). For example, the first elongate member 114 can couple to the leg support 102 via one or more mechanical linkages such that movement of the first elongate member 114 translates to movement of the leg support 102.

In some aspects, the first elongate member 114 can operatively couple to the second elongate member 116 (which may also be referred to herein as a follower rod) such that movement of the first elongate member 114 causes movement (e.g., an equal movement) of the second elongate member 116. For example, the first elongate member 114 can couple to the second elongate member via a link (e.g., coupling) 118. The link 118 can be positioned proximate a top end of the first elongate member 114 and the second elongate member 116. The second elongate member 116 can be positioned adjacent and/or parallel to the first elongate member 114. In some aspects, the second elongate member 116 can couple to the leg support 102 (e.g., via the link 120) to drive movement of the leg support 102 between the extended and retracted positions. In some aspects, the actuator support 110 does not include the second elongate member 116. In such aspects, the first elongate member 114 may couple (e.g., directly or indirectly) to the leg support 102, for example, via the link 120.

The actuator support 110 can include one or more bearings (e.g., linear bearings) 122. For example, the actuator support 110 can include one, two, three, four, five, six, or more than six bearings 122. The second elongate member 116 can be disposed in (e.g., extend through) the one or more bearings 122. The elongate member 116 can move (e.g., translate) through the bearings 122 as the actuator 112 moves the first elongate member 114 between the extended and retracted positions. The linear bearings 122 can smooth the linear movement of the second elongate member 116 (and thus the leg support 102) and/or help distribute loads applied through the second elongate member 116 (e.g., due to the weight of the patient on the leg support 102 and/or the force exerted by the actuator 112). Providing a plurality of bearings 122 may better distribute forces applied through the second elongate member 116.

In some aspects, the bearings 122 can couple to a housing (e.g., actuator housing) 124. The actuator housing 124 can at least partially house various components of the actuator support 110, for example, the actuator 112, the bearings 122, and/or the elongate members 114, 116. In some aspects, the actuator housing 124 can be elongate in shape which may help accommodate the elongate members 114, 116. In some aspects, a rear portion of the housing 124 can be longer than a front portion of the housing 124 to accommodate the full range of movement (e.g., translation) of the second elongate member 116. The housing 124 may help prevent debris from becoming entrapped in portions of the actuator support 110 and/or may inhibit caregivers or patients from being pinched by moving components of the actuator support 110.

The actuator support 110 can couple (e.g., directly or indirectly) to the support member 170 and/or at least one of the engagement assemblies 140, 160. In some aspects, the support member 170, the actuator support 110, and the leg support 102 can form a C-shape structure. For example, the actuator support 110 and the leg support 102 can form an L-shape, and/or the actuator support 110 and the support member 170 can form an L shape. The actuator support 110 can pivot about an axis which can be parallel to or colinear with a longitudinal axis of the support member 170. The support member 170 (e.g., the longitudinal axis thereof) can extend transverse to the longitudinal axis of the bed 10 (e.g., the mattress 12). For example, the support member 170 can extend partially or entirely across a width of the mattress 12. In some aspects, the support member 170 can be disposed underneath the mattress 12 and/or the frame 16 of the bed 10 which may improve the stability of the lifting device 100. In some aspects, the support member 170 can be disposed distal to the mattress 12, for example, between the mattress 12 and the footboard 14 of the bed 10 or distal to the footboard 14 of the bed 10. In some aspects, the support member 170 can be disposed above the mattress 12 or between a top and bottom surface of the mattress 12. In some aspects, the support member 170 can include one or more beams (e.g., cross beams), arms, frames, brackets, and/or other support structures which can add stability to the lifting device 100 and/or couple the lifting device 100 to the bed 10. The support member 170 may extend above, below, adjacent to, or through portions of the bed 10 or mattress 12. The support member 170 may include beams, arms, frames, brackets, rails, or other support structures.

A length of the support member 170 can be adjustable to accommodate beds of different widths. In some aspects, the support member 170 can be telescoping. For example, the support member 170 can include an outer member (e.g., sleeve) 172 and an inner member (e.g., rod) 174 shaped to fit at least partially within the outer member 172. The inner and outer members 172, 174 can translate with respect to each other to adjust a length of the support member 170. The support member 170 can couple to (e.g., extend between) the first engagement assembly 140 and the second engagement assembly 160. In some aspects, the inner member 174 can couple to the first engagement assembly 140 and the outer member 172 can couple to the second engagement assembly 160. This can permit adjustment of a distance (e.g., width) between the engagement assemblies 140, 160. In some aspects, the support member 170 may be repositionable relative to the engagement assemblies 140, 160, for example, along a longitudinal or vertical axis of the bed 10.

The engagement assemblies 140, 160 can (e.g., removably) couple to the frame 16 of the bed 10 to couple the lifting device 100 to the bed 10. In some aspects, the engagement assemblies 140, 160 can couple to opposite sides (e.g., lateral sides) of the bed frame 16 which may increase the stability of the lifting device 100. For example, the first engagement assembly 140 can couple to a first lateral (e.g., left) side of the bed frame 16 while the second engagement assembly 160 couples to a second lateral (e.g., right) side of the bed frame 16. The engagement assemblies 140, 160 may couple to the bed frame 16 via one or more clamps, straps, brackets, fasteners, rails, or any other appropriate mechanism to secure the lifting device 100 to the bed frame 16. As described further herein, the engagement assemblies 140, 160 can couple to the bed frame 16 at a plurality of locations (e.g., along a length, height, and/or width of the bed frame 16) to accommodate bed frames of different types, shapes, and/or dimensions. In some aspects, the lifting device 100 includes only one of the engagement assemblies 140, 160 which may increase the ease of coupling and decoupling the lifting device 100 from a bed frame 16. In such aspects, the support member 170 can couple to (e.g., extend from) one of the engagement assemblies 140, 160 at a first end. The support member 170 can extend across a partial or total width of the bed 10 and/or mattress 12 to a second (e.g., free) end. The support member 170 may asymmetrically span the bed 10.

Turning to FIGS. 2H and 2I, the first engagement assembly 140 can include a frame 142 and a movable jaw 148. In some aspects, the frame 142 can be C-shaped to accommodate (e.g., at least partially surround) the shape of the bed frame 16 (as shown, for example, in FIG. 2I). For example, the frame 142 can include a top wall 145, a sidewall 146, and/or a bottom wall 147. In some aspects, the top wall 145 can act as a fixed jaw of the engagement assembly 140. A surface (e.g., horizontal surface) of the bed frame 16 can be secured (e.g., clamped) between the frame 142 (e.g., the top wall 145) and the movable jaw 148 to couple the engagement assembly 140 (and thus the lifting device 100) to the bed 10 (as shown, for example, in FIG. 2I). In some aspects, a sidewall of the bed frame 16 can be positioned between (e.g., secured between) the frame 142 (e.g., the sidewall 146) and the movable jaw 148.

The movable jaw 148 can include a clamping member (e.g., plate) 149, a fastener (e.g., threaded fastener, screw) 150, a handle 152, and/or one or more receiving members (e.g., threaded fasteners, nuts) 154. The clamping member 149 can contact and exert a force (e.g., upward force) on the bed frame 16 to couple the lifting device 100 to bed frame 16 and/or maintain a position of the lifting device 100 relative to the bed frame 16. For example, the clamping member 149 can press the bed frame 16 against the frame 142 (e.g., the top wall 145) to prevent or limit movement of the engagement assembly 140 relative to the bed frame 16.

The clamping member 149 can couple to the fastener 150 such that (e.g., vertical) translation of the fastener 150 causes a corresponding (e.g., vertical) translation of the clamping member 149. The position (e.g., height) of the clamping member 149 can be controlled via the handle 152. For example, the handle 152 can be rotated in a first direction to cause the fastener 150 and the clamping member 149 to move (e.g., upward) toward the frame 142 (e.g., the top wall 145) to clamp the bed frame 16, thereby coupling the lifting device 100 to the bed 10. The handle 152 can be rotated in a second, opposite direction to cause the fastener 150 and the clamping member to move (e.g., downward) away from the frame 142 (e.g., the top wall 145) to unclamp the bed frame 16, thereby decoupling the lifting device 100 from the bed 10. In some aspects, the handle 152 can extend beyond the frame 142 which may improve accessibility for a caregiver. For example, the handle 152 may be positioned below, above, or lateral to the frame 142.

In some aspects, the fastener 150 can extend through the receiving member(s) 154. The receiving members 154 can translate rotational movement of the fastener 150 (e.g., via rotation of the handle 152) into translational (e.g., vertical) movement of the fastener 150 (and thus the clamp member 149). The receiving members 154 can maintain a current height of the fastener 150 (and thus the clamp member 149) in the absence of rotation of the handle 152. The receiving members 154 can (e.g., movably) couple the fastener 150 (and thus the movable jaw 148) to the frame 142.

In some aspects, the frame 142 (e.g., the bottom wall 147) can include a slot 155. The movable jaw 148 can be movable (e.g., translatable) along the length of the slot 155 to reposition the movable jaw 148 relative to the frame 142. Repositioning the movable jaw 148 relative to the frame 142 can allow for adjustment of a position of the lifting device 100 and components thereof (e.g., the leg support 102, the support member 170, and/or the actuator support 110) relative to the bed 10 (e.g., the bed frame 16) when the engagement assembly 140 couples to the bed frame 16. In some aspects, the slot 155 can extend along a length of the frame 142 which may be partially or substantially parallel to the longitudinal axis of the bed 10 (e.g., the bed frame 16). In such aspects, repositioning the movable jaw 148 along the slot 155 can adjust the position of the lifting device 100 and components thereof (e.g., the leg support 102, the support member 170, and/or the actuator support 110) along the length of the bed 10 (e.g., toward and away from the footboard 14 of the bed 10). This may enable the lifting device 100 to more easily accommodate patients of different heights. For example, the leg support 102 can be moved toward the footboard 14 of the bed 10 for taller patients and toward the head of the bed for shorter patients. Repositioning the movable jaw 148 may also help the engagement assembly 140 accommodate (e.g., couple to) bed frames 16 of different shapes and/or dimensions. In some aspects, the slot 155 can instead extend partially or substantially transverse to the longitudinal axis of the bed 10 (e.g., the bed frame 16). The movable jaw 148 may be repositioned relative to the frame 142 via slots, rails, slides, tracks, bearings, telescoping members, articulating members, or other positioning mechanisms. The engagement assemblies 140, 160 may reposition along one or more vertical, longitudinal, and lateral axes. The slot 155 also allows the coupling force applied by the clamping member 149 to be applied at different positions for a same position of the frame 142. This enables the frame 142 to be positioned as desired and the clamping member 149 to be located where appropriate, even if the bed frame has an obstruction within a length of the slot 155.

In some aspects, the fastener 150 can extend through the slot 155. For example, the slot 155 can be shaped and/or sized to permit translation of the fastener 150 within the slot 155. In some aspects, two receiving members (e.g., screws) 154 can be positioned on opposite (e.g., top and bottom) sides of the slot 155. The receiving members 154 can help retain a position of the fastener 150 (and thus the movable jaw 148) relative to the slot 155. For example, the receiving members 154 can be loosened (e.g., moved away from each other and/or the slot 155) to permit movement of the fastener 150 within the slot 155 to permit repositioning of the movable jaw 148 relative to the frame 142. Once the movable jaw 148 is in the desired position, the receiving members 154 can be tightened (e.g., moved toward each other and/or the slot 155) to prevent or inhibit further movement of the fastener 150 within the slot to retain the movable jaw 148 in the desired position relative to the frame 142.

The second engagement assembly 160 can include any of the features described with respect to the first engagement assembly 140. In some aspects, the second engagement assembly 160 can be a mirrored version of the first engagement assembly 140, for example, across a longitudinal axis of the lifting device 100 and/or the bed 10.

Turning to FIG. 2J, the lifting device 100 can include the stop (e.g., pivot stop) 162. As described herein, the stop 162 can limit movement (e.g., pivotable movement) of the actuator support 110 (and thus the leg support 102) in the first and/or second directions (e.g., toward the deployed and stowed positions). For example, the stop 162 can physically contact the actuator support 110 to inhibit or prevent further movement of the actuator support 110 toward the deployed and/or stowed positions (e.g., in the first and/or second rotational directions, respectively). In some aspects, the stop 162 can be angled relative to vertical (e.g., toward a proximal end or head of the bed 10) such that the actuator support 110 is angled relative to vertical (e.g., toward a proximal end or head of the bed 10) when in the deployed position. For example, the stop 162 can form an angle θ₁ relative to a vertical axis VA. When moved (e.g., pivoted) to the deployed position, the actuator support 110 (e.g., a front wall thereof) can abut the stop 162 such that the actuator support 110 forms an angle relative to vertical that is equal or substantially equal to the angle θ₁. Angling the actuator support 110 relative to vertical (e.g., toward a proximal end of head of the bed 10) may improve the stability and/or load bearing capability of the actuator support 110 when in the deployed position. In some aspects, θ₁ can be 20 degrees or approximately 20 degrees, for example, between 0 degrees and 45 degrees, between 5 degrees and 35 degrees, between 10 degrees and 30 degrees, between 15 degrees and 25 degrees, or any value or range within or bounded by any of these values or ranges. In some aspects, movement of the actuator support 110 toward the stowed position (e.g., in the second rotational direction) can be limited via contact with the limit stop 162. In some aspects, movement of the actuator support 110 toward the stowed position may additionally or alternatively be limited by contact between the leg support 102 and the bed 10.

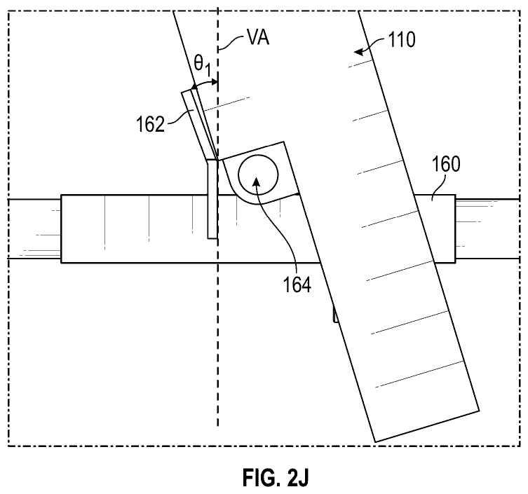

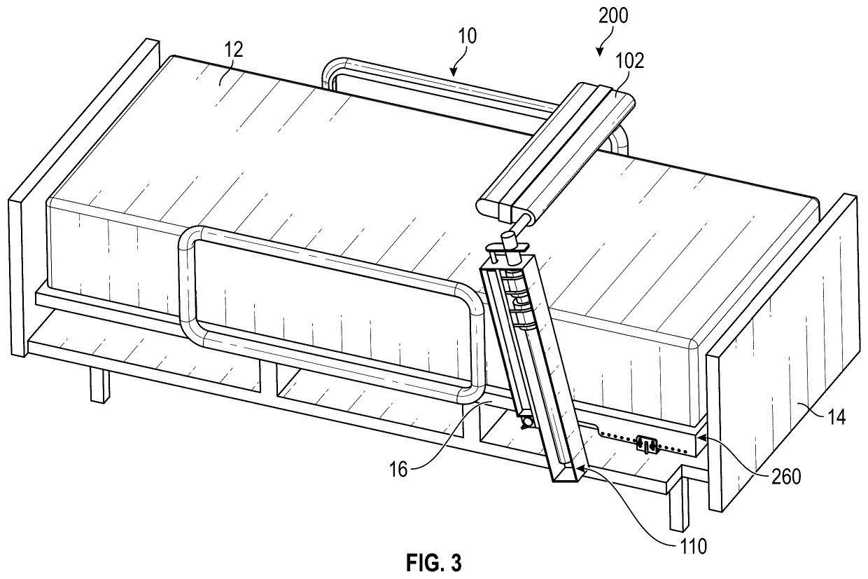

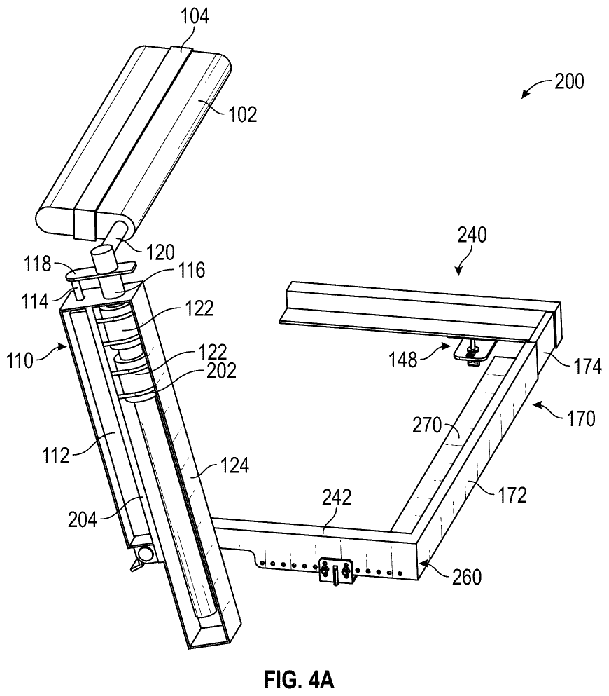

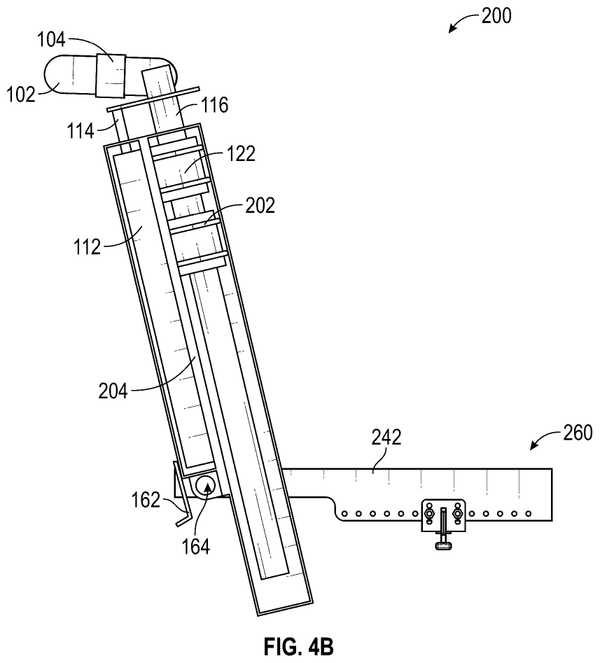

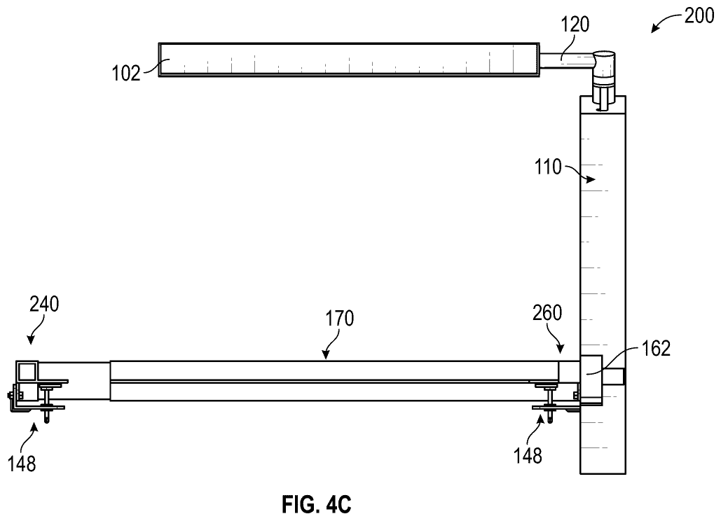

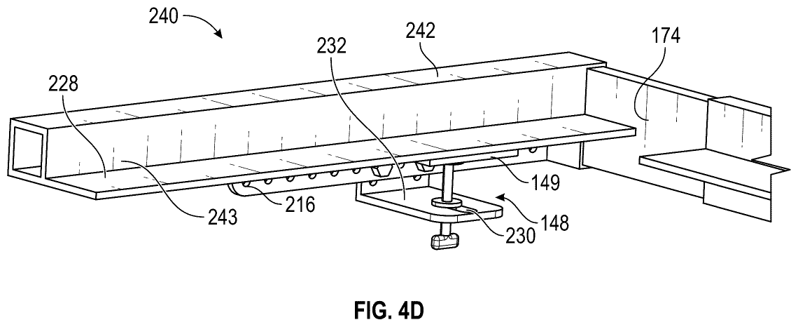

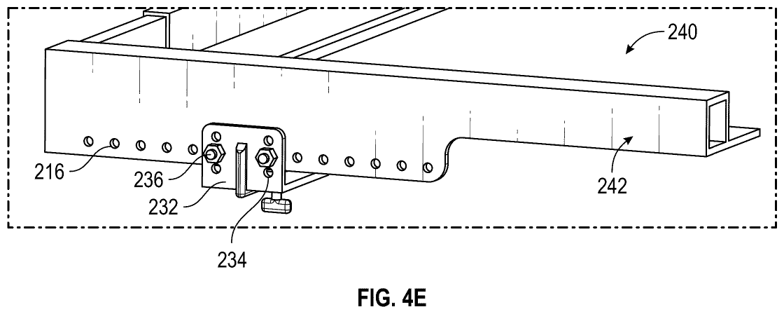

FIGS. 3-4F illustrate various views of a leg lifting device 200 and components thereof. The leg lifting device 200 can include any of the features and/or functionalities described with respect to any of the other leg lifting devices described herein. The features of the leg lifting device 200 can be combined with the features of any of the other leg lifting devices described herein in various modified embodiments.

As shown in at least FIG. 4A, the housing 124 of the actuator support 110 can include a support (e.g., support wall) 204. The support 204 can separate the actuator 112 from the second elongate member 116. In some aspects, the support 204 can divide the housing 124 into a first compartment and second compartment. In other aspects, the support 204 can provide a bracing of the structure without separating the housing 124 into separate compartments. The first compartment can house the actuator 112 and/or the first elongate member 114. The second compartment can house the second elongate member 114 and/or the bearings 122. The one or more bearings 122 can couple to the support 204 (e.g., to transfer torque between the bearings 122 and the support 204). In some aspects, the support 204 can transfer forces (e.g., torques) between the bearings 122 and the pivot (e.g., joint) 164 which may increase the stability and/or maximum load of the lifting device 200. The bearings 122 can couple to the support 204 via one or more fasteners 202. In some aspects, the one or more fasteners 202 can include U-bolts.

The lifting device 200 can include one or more engagement assemblies, e.g., a first engagement assembly 240 and/or a second engagement assembly 260. The engagement assembly or assemblies which can include any of the features and/or functionalities described with respect to any of the other engagement assemblies described herein. The engagement assembly 240 can be utilized in any of the lifting devices disclosed herein. The support member 170 can couple (e.g., extend between) the retention assemblies 140, 160. In some aspects, the support member 170 can extend between a distal end of the engagement assemblies 240, 260. As shown in at least FIG. 3, the support member 170 can be disposed proximate a distal end of the mattress 12, for example, between the mattress 12 and the footboard 14 of the bed. In some aspects, the support member 170 can include a foot 270 which can extend (e.g. proximally) from the support member 170 (e.g., the outer member 172). The foot 270 can be positioned between the mattress 12 and the bed frame 16 (e.g., beneath the mattress and above the bed frame 16) which may increase the stability of the lifting device 200.

With reference to FIGS. 4D-4F, the engagement assembly 240 can include a frame 242 and the movable jaw 148. The frame 242 can include any of the features and/or functionalities described with respect to any of the other frames described herein. The frame 242 can be utilized with any of the lifting devices disclosed herein. In some aspects, the frame 242 can include a beam 243 which can be disposed adjacent (e.g., lateral to) the mattress 12 and/or the bed frame 16. The frame 242 can extend along and/or exterior to the mattress 12 and/or the bed frame 16. In some aspects, the frame 242 can include a foot 228 extending from the beam 243. The foot 228 can extend laterally (e.g., inward) from the beam 243. In some aspects, the foot 228 can act as a fixed jaw for clamping the bed frame 16 (as shown, for example, in FIG. 4F). For example, the foot 228 can cooperate with the movable jaw 148 couple the lifting device 200 to the bed 10 (e.g., via clamping the bed frame 16 between the foot 228 and the movable jaw 148).

In some aspects, the movable jaw 148 can removably couple to the frame 242 at a plurality of selectable positions which may enable the lifting device 200 to more readily couple to bed frames 16 of different types, shapes, and/or sizes. In some aspects, the position of the movable jaw 148 relative to the frame 242 when coupled together can be adjusted in one, two, or three dimensions. For example, the position of the movable jaw 148 when coupled to the frame 242 can be adjusted along the direction of a longitudinal, lateral, and/or vertical axis of the frame 242 (e.g., which may extend parallel or substantially parallel to a longitudinal, lateral, and/or vertical axis of the bed 10 and/or bed frame 16, respectively).

In some aspects, the moveable jaw 148 can couple to the frame 242 via a plate (e.g., securement plate) 232. The plate 232 may be L-shaped. The plate 232 can include a slot 230 which can include any of the features and/or functionalities described with respect to the slot 155. For example, the movable jaw 148 can move along the slot 230 to adjust a position of the moveable jaw 148 relative to the plate 232 and/or the frame 242. In some aspects, the slot 230 can extend in a direction of the lateral axis of the frame 242 which can extend parallel or substantially parallel to the lateral axis of the bed 10 and/or bed frame 16. The moveable jaw 148 can be moved along the slot 230 to adjust a lateral position of the moveable jaw 148 relative to the bed 10 (e.g., bed frame 16). In some aspects, the slot 230 can extend in a direction of the longitudinal or vertical axis of the frame 242 such that the moveable jaw 148 can be moved along the slot 230 to adjust a longitudinal or vertical position of the moveable jaw 148 relative to the bed 10, respectively. In some aspects, the plate 232 can include a plurality of openings instead of a slot 230. The moveable jaw 148 can be selectively retained at different openings (e.g., via one or more fasteners) to adjust a (e.g., lateral) position of the moveable jaw 148 relative to the bed 10.

In some aspects, the frame 242 can include a plurality of openings 216 extending along the longitudinal axis of the frame 242 (which can extend parallel or substantially parallel to the longitudinal axis of the bed frame 16 or bed 10). The moveable jaw 148 can be selectively retained at a variety of selectable longitudinal positions via the openings 216. For example, the plate 232 can include one or more openings 234 which can be aligned with different openings 216 along the longitudinal axis of the frame 242. One or more fasteners 236 (e.g., bolts, screws, etc.) can be disposed in (e.g., through) the openings 216 of the frame 242 and the openings 234 of the plate 232 to secure the plate 232 (and thus the moveable jaw 248) to the frame 242 at a desired longitudinal position. A caregiver can couple the plate 232 to the frame 242 at different opening(s) 216 to adjust a longitudinal position of the movable jaw 248 relative to the bed 10 or bed frame 16 (e.g., based on the type, shape, and/or size of the bed frame 16). In some aspects, the frame 242 can include a slot instead of a plurality of openings 216. The plate 232 can be selectively retained at different longitudinal positions along the slot, for example, in a similar or identical manner as described with respect to slot 155.

In some aspects, the plate 232 can include a plurality of openings 234 extending along a vertical axis of the plate 232 (which can extend parallel or substantially parallel to the vertical axis of the bed frame 16 or bed 10). The moveable jaw 148 can be selectively retained at a variety of vertical positions via the openings 234. For example, different (e.g., vertically spaced) openings 234 of the plate 232 can be aligned with openings 216 of the frame 242. Once the desired openings 216, 234 are aligned, the fasteners 236 (e.g., bolts, screws, etc.) can be disposed in (e.g., through) the openings 216, 234 to secure the plate 232 (and thus the moveable jaw 248) to the frame 242 at a desired vertical position. A caregiver can couple the plate 232 to the frame 242 at different opening(s) 234 to adjust a vertical position of the movable jaw 248 relative to the bed 10 or bed frame 16 (e.g., based on the type, shape, and/or size of the bed frame 16). In some aspects, the plate 232 can include a slot instead of a plurality of openings 234. The plate 232 can be selectively retained at different vertical positions along the slot, for example, in a similar or identical manner as described with respect to slot 155.

The second engagement assembly 260 can include any of the features described with respect to the first engagement assembly 240. In some aspects, the second engagement assembly 260 can be a mirrored version of the first engagement assembly 240, for example, across a longitudinal axis of the lifting device 200 and/or the bed 10.

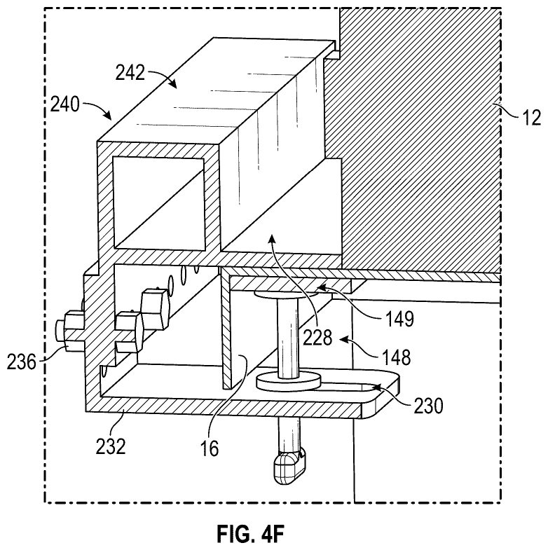

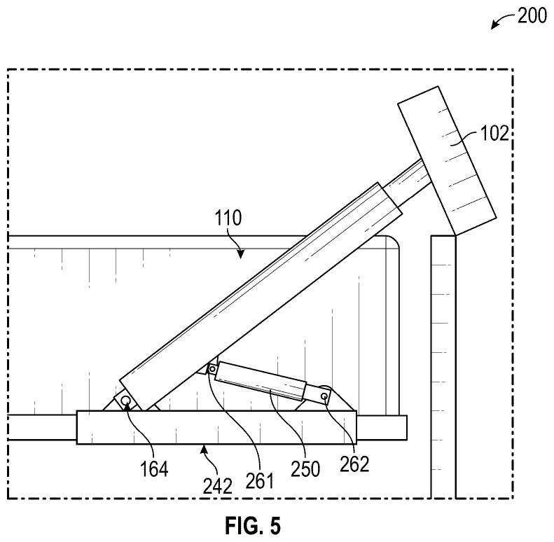

FIG. 5 illustrates a side view of the lifting device 200 including an actuator 250 (which may be referred to herein as a deployment actuator). The actuator 250 can extend between (e.g., couple to) the frame 242 and the actuator support 110. The actuator 250 can pivotably couple to the frame 242 and/or the actuator support 110. The actuator 250 can transition the lifting device 200 between the deployed and stowed positions, for example, by moving (e.g., pivoting) the actuator support 110. The actuator 250 can include a linear actuator that can linearly displace (e.g., extend and retract) a driven member to transition the actuator support 110. For example, the actuator 250 can extend (e.g., the driven member) to push the actuator support 110 toward the deployed position. The actuator 250 can retract (e.g., the driven member) to pull the actuator support 110 toward the stowed position. The actuator 250 can include one or more (e.g., electric) motors and/or one more hydraulic, pneumatic, piezoelectric, or magnetic actuator systems for generating linear motion. In some aspects, an actuator may be angularly offset from a travel path of the leg support 102 and coupled to the leg support 102 at a location spaced from a pivot axis of the actuator support 110. In some aspects, a single actuator may drive movement of the lifting device 200 through multiple positions, for example, the stowed, deployed, extended, and/or retracted positions.

The actuator 250 may increase the ease with which a caregiver can transition the lifting device 200 between the stowed and deployed positions, and/or allow the caregiver to more easily position the patient's legs on the leg support 102 when transitioned to the deployed positions. For example, the caregiver can hold the patients legs up in the air while the actuator 250 transitions the lifting device 200 to the deployed position. Once in the deployed position, the caregiver can lower the patient's legs onto the leg support 102. In some aspects, the actuator 250 can control the angle of the actuator support 110 when in the stowed and/or deployed positions (e.g., in addition to or as an alternative to the stop 162). For example, the maximum extension of the actuator 250 (e.g., the driven rod) can control the angle of the actuator support 110 in the deployed position. The minimum extension (e.g., maximum retraction) of the actuator 250 (e.g., the driven rod) can control the angle of the actuator support in the stowed position as shown, for example, in FIG. 5.

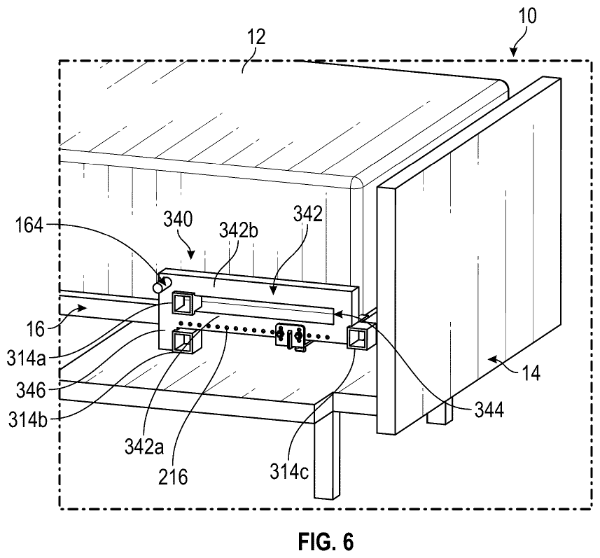

FIG. 6 illustrates a perspective view of an engagement assembly 340 of a leg lifting device (e.g., leg lifting devices 100, 200) engaged with (e.g., coupled to) the bed frame 16 of the bed 10. The engagement assembly 340 can include any of the features and/or functionalities described with respect to any of the other engagement assemblies described herein. The features of the engagement assembly 340 can be combined with the features of any of the other engagement assemblies described herein in various modified embodiments. The engagement assembly 340 can be utilized in any of the leg lifting devices disclosed herein. For example, the engagement assembly 340 can pivotably couple to the actuator support 110 via the pivot (e.g., joint) 164.

The engagement assembly 340 can include a frame 342 which can include any of the features and/or functionalities described with respect to other frames described herein. The frame 342 can extend along and/or exterior to the mattress 12 and/or the bed frame 16. In some aspects, the frame 342 can include a first beam 342a and/or a second beam 342b. The beams 342a, 342b can include any of the features and/or functionalities described with respect to the beam 243. For example, the first beam 342a can extend along (e.g., lateral to) the frame 16. The first beam 342a can include the plurality of openings 216 extending along a length of the first beam 342a. In some aspects, the movable jaw 218 can removably couple to the first beam 342a at a plurality of positions (e.g., along the length of the first beam 342a at different openings 216). The beams 342a, 342b can extend parallel to the longitudinal axis of the bed 10. The second beam 342b can extend parallel to the first beam 342a, for example, above the first beam 342a. The beams 342a, 342b can be (e.g., vertically) spaced by a gap (e.g., slot) 344.

In some aspects, the frame 342 can include one or more mounting locations 314a, 314b, 314c where the support member 170 can mount to the frame 342. The support member 170 can removably mount to the frame 342 at different mounting locations 314a, 314b, 314c to accommodate beds and/or bed frames of different shapes and/or sizes. The mounting locations 314a, 314b, 314c can include one or more receptacles shaped and/or sized to receive the support member 170. In some aspects, the mounting locations 314a, 314b, 314c can include one or more fasteners to removably couple the support member 170 to the frame 342. In other aspects, the support member 170 can be fixed to the frame 342 at a mounting location 314a, 314b, 314c, for example, via welding or being integrally formed with the frame 342.

The mounting location 314a can be positioned between the first and second beams 342a, 342b, for example, within the gap 344. In some aspects, the mounting location 314a can be positioned proximate a proximal end of the frame 342. The support member 170 can be positioned between the mattress 12 and the bed frame 16 when coupled to the frame 342 at the mounting location 314a. The mounting location 314b can be positioned below first beam 342a. In some aspects, the mounting location 314b can be positioned proximate a proximal end of the frame 342. For example, the mounting location 314b can abut a leg 346 that extends from a proximal end of the first beam 342a. The support member 170 can be positioned below the bed frame 16 when coupled to the frame 342 at the mounting location 314b. The mounting location 314c can be positioned proximate a distal end of the frame 342, for example, exterior to the frame 342. The support member 170 can be positioned distal to the bed frame 16 and/or the mattress 12 when coupled to the frame 342 at the mounting location 314c. For example, the support member 170 can be positioned between the footboard 14 of the bed 10 and the bed frame 16 and/or the mattress 12 when coupled to the frame 342 at the mounting location 314c.

FIGS. 7A-8C illustrate various views of a leg lifting device 400 and components thereof. The leg lifting device 400 can include any of the features and/or functionalities described with respect to any of the other leg lifting devices described herein. The features of the leg lifting device 400 can be combined with the features of any of the other leg lifting devices described herein in various modified embodiments. For example, the lifting device 400 can be transitioned (e.g., moved, pivoted) between a stowed position (as shown, for example, in FIGS. 7A & 8A) and a deployed position (as shown, for example, in FIGS. 7B, 7C, 8B, & 8C). As described herein, the lifting device 400 can have a reduced footprint when in the stowed position which may improve caregiver access to the bed 10 and/or reduce the risk of collision with the lifting device 400 when not in use. For example, the lifting device 400 (e.g., one or more components thereof) can pivot, fold, and/or collapse (e.g., toward the actuator support 110) when in the stowed position. The lifting device 400 can additionally be transitioned between a retracted position (as shown, for example, in FIGS. 7A, 7B, 8A, & 8B) and an extended position (as shown, for example, in FIGS. 7C & 8C).

The lifting device 400 can include a leg support assembly 401 coupled (e.g., pivotably) to the actuator support 110. The leg support assembly 401 (e.g., one or more components thereof) can pivot and/or fold toward the actuator support 110 when the lifting device 400 is transitioned toward the stowed position to decrease the footprint of the lifting device 400. When in the stowed position, the leg support assembly 401 can be positioned adjacent the actuator support 110. For example, the leg support assembly 401 can be positioned lateral to the actuator support 110. In some aspects, the actuator support 110 can be positioned between the bed 10 and the leg support assembly 401 when the lifting device 400 is in the stowed position. In some aspects, the leg support assembly 401 can contact and/or extend partially or substantially parallel to the actuator support 110 when in the stowed position. The leg support assembly 401 (e.g., one or more components thereof) can pivot and/or unfold away from the actuator support 110 when the lifting device 400 is transitioned toward the deployed position to position the leg support assembly 401 over the bed 10 (e.g., the mattress 12 thereof) and/or to provide access to one or more (e.g., two) leg supports 402, 404 of the leg support assembly 401. When in the deployed position, the leg support assembly 401 (e.g., a longitudinal axis thereof) can extend transverse to the longitudinal axis of the bed 10. For example, the leg support assembly 401 can extend (e.g., partially or entirely) across a width of the bed 10.

The leg support assembly 401 can be raised and lowered as the lifting device 400 is transitioned between the extended and retracted positions, respectively (e.g., as the first and/or second elongate members 114, 116 are extended and retracted by the actuator 112). For example, the leg support assembly 401 and components thereof can be positioned at a higher elevation when the lifting device 400 is in the extended position than when the lifting device 400 is in the retracted position.

The lifting device 400 (e.g., the leg support assembly 401) can include a support member (e.g., arm, beam) 410, one or more (e.g., two) arms 406, 408, and/or the leg supports 402, 404. The support member 410 can couple (e.g., pivotably) to the actuator support 110. For example, the support member 410 can couple to the first and/or second elongate members 114, 116 (e.g., via the link 118) such that the actuator 112 can transition the leg support assembly 401 between the extended and retracted positions. In some aspects, the support member 410 can pivotably couple to the actuator support 110 (e.g., via the link 118 and/or the elongate members 114, 116). For example, the support member 410 can pivot about a pivot (e.g., joint) 416 which may define a pivot axis of the support member 410. In some aspects, the pivot axis of the support member 410 can extend transverse to a longitudinal axis of the actuator support 110. The support member 410 can be pivoted about the pivot axis (e.g., pivot 416) when the lifting device 400 is transitioned between the stowed and deployed positions. For example, the support member 410 can be pivoted in a first rotational direction (e.g., toward the actuator support 110, clockwise in the view of FIGS. 8A-8C) when the lifting device 400 is transitioned to the stowed position. The support member 410 can be pivoted in a second, opposite rotational direction (e.g., away from the actuator support 110, counterclockwise in the view of FIGS. 8A-8C) when the lifting device 400 is transitioned to the deployed position.

When in the stowed position, the support member 410 can be positioned adjacent to the actuator support 110. For example, the support member 410 can be positioned lateral to the actuator support 110. In some aspects, the support member 410 can contact the actuator support 110 in the stowed position. The support member 410 (e.g., a longitudinal axis thereof) can extend parallel to the actuator support 110 (e.g., the longitudinal axis thereof) when in the stowed position. In some aspects, the pivot 416 can be positioned lateral to (e.g., an outer wall) of the actuator support 110 which may enable the support member 410 to pivot to a position adjacent the actuator support 110. When in the deployed position, the support member 410 (e.g., the longitudinal axis thereof) can extend transverse to the longitudinal axis of the bed 10. For example, the support member 410 can extend (e.g., partially or entirely) across a width of the bed 10.

The support member 410 can couple (e.g., pivotably) to the leg supports 402, 404. For example, the leg supports 402, 404 can pivotably couple to the support member 410 via the arms 406, 408, respectively. The leg support 402 can pivotably couple to the support member 410 via the arm 406 proximate a first (e.g., coupled) end of the support member 410. The leg support 404 can pivotably couple to the support member 410 via the arm 408 proximate a second, opposite (e.g., free) end of the support member 410. In some aspects, the leg supports 402, 404 can couple to the support member 410 via one or more cables in addition to or as an alternative to the arms 406, 408. For example, each leg support 402, 404 can be suspended from the support member 410 via a plurality of (e.g., two or more) cables. In such aspects, the position (e.g., height) of the leg supports 402, 404 (e.g., relative to the support member 410) can be adjusted by actuating (e.g., pulling and/or releasing) the cables.

The arms 406, 408 can couple (e.g., pivotably) to the support member 410. For example, the arm 406 can pivotably couple to the support member 410 proximate the first end of the support member 410, and/or the arm 408 can pivotably couple to the support member 410 proximate the second end of the support member 410. In some aspects, the arm 406 can pivot about a pivot (e.g., joint) 412 which may define a first pivot axis of the arm 406. The arm 408 can pivot about a pivot (e.g., joint) 414 which may define a first pivot axis of the arm 408. In some aspects, the first pivot axes of the arms 406, 408 can extend transverse to the longitudinal axis of the support member 410. The arms 406, 408 can be pivoted about their respective first pivot axis when the lifting device 400 is transitioned between the stowed and deployed positions. For example, the arms 406, 408 can pivot toward the support member 410 when the lifting device 400 is transitioned to the stowed position and/or away from the support member 410 when the lifting device 400 is transitioned to the deployed position. In some aspects, the arms 406, 408 can pivot in opposite rotational directions from each other when transitioned between the deployed and stowed positions. For example, when transitioning to the stowed position, the arm 406 can pivot in a first rotational direction (e.g., clockwise in the view of FIG. 8B) and the arm 408 can pivot in a second, opposite rotational direction (e.g., counterclockwise in the view of FIG. 8B). When transitioning to the deployed position, the arm 406 can pivot in the second rotational direction (e.g., counterclockwise in the view of FIG. 8B) and the arm 408 can pivot in the first rotational direction (e.g., clockwise in the view of FIG. 8B). This may decrease the footprint of the leg support assembly 401 when in the stowed position.

When in the stowed position, the arms 406, 408 can be positioned adjacent to the support member 410. For example, the arms 406, 408 can be positioned lateral to the support member 410. In some aspects, the arms 406, 408 can contact the support member 410 in the stowed position. The arms 406, 408 (e.g., a longitudinal axis thereof) can extend parallel to the support member 410 (e.g., the longitudinal axis thereof) when in the stowed position. When in the deployed position, the arms 406, 408 (e.g., the longitudinal axis thereof) can extend transverse to the longitudinal axis of the bed 10 and/or the longitudinal axis of the support member 410. For example, the arms 406, 408 can extend vertically (e.g., downward) from the support member 410.

The leg supports 402, 404 can couple (e.g., pivotably) to the arms 406, 408, respectively. For example, leg support 402 can pivotably couple to the arm 406 proximate a distal (e.g., free) end of the arm 406. The leg support 404 can pivotably couple to the arm 408 proximate a distal (e.g., free) end of the arm 408. In some aspects, the leg support 402 can pivot about a pivot (e.g., joint) 403 which may define a pivot axis of the leg support 402. The leg support 404 can pivot about a pivot (e.g., joint) 405 which may define a pivot axis of the leg support 404. In some aspects, the pivot axes of the leg supports 402, 404 can extend transverse to the longitudinal axis of the arms 406, 408, respectively, and/or the support member 410. The pivot axes of the leg supports 402, 404 may extend parallel to the first pivot axes of the arms 406, 408.

The leg supports 402, 404 can be pivoted about their respective pivot axis (e.g., pivots 403, 405) when the lifting device 400 is transitioned between the stowed and deployed positions. For example, the leg supports 402, 404 can pivot toward the respective arm 406, 408 (e.g., upward) when the lifting device 400 is transitioned to the stowed position and/or away from the respective arm 406, 408 (e.g., downward) when the lifting device 400 is transitioned to the deployed position. In some aspects, the leg supports 402, 404 can pivot in opposite rotational directions from each other when transitioned between the deployed and stowed positions. For example, when transitioning to the stowed position, the leg support 402 can pivot in a first rotational direction (e.g., clockwise in the view of FIG. 8B) and the leg support 404 can pivot in a second, opposite rotational direction (e.g., counterclockwise in the view of FIG. 8B). When transitioning to the deployed position, the leg support 402 can pivot in the second rotational direction (e.g., counterclockwise in the view of FIG. 8B) and the leg support 404 can pivot in the first rotational direction (e.g., clockwise in the view of FIG. 8B). This may decrease the footprint of the leg support assembly 401 when in the stowed position.

When in the stowed position, the leg supports 402, 404 can be positioned adjacent to the respective arm 406, 408. For example, the leg supports 402, 404 can be positioned lateral to the respective arm 406, 408. In some aspects, the leg supports 402, 404 can contact the respective arm 406, 408 in the stowed position. The leg supports 402, 404 (e.g., a longitudinal axis thereof) can extend parallel to the respective arm 406, 408 (e.g., the longitudinal axis thereof) when in the stowed position. The arms 406, 408 can include a recessed portion 407 shaped and/or sized to at least partially receive the respective leg support 402, 404 (as shown, for example, in FIGS. 8A & 8B). The leg supports 402, 404 can be positioned at least partially within the recessed portion 407 of the respective arm 406, 408 when in the stowed position (e.g., when pivoted toward the respective arm 406, 408) which may reduce the footprint of the leg support assembly 401. In some aspects, the arms 406, 408 can include a first (e.g., linear) portion and a second (e.g., linear) portion offset (e.g., laterally) from the first linear portion to form the recessed portion 407.

When in the deployed position, the leg supports 402, 404 (e.g., a longitudinal and/or lateral axis thereof) can extend partially or substantially parallel to the mattress 12. In some aspects, the leg supports 402, 404 can be planar. In such aspects, the leg supports 402, 404 can extend in plane with each other. In some aspects, a plane extending through (e.g., defined by) the leg supports 402, 404 can extend parallel to a plane extending through the longitudinal and lateral axis of the bed 10 (e.g., the mattress 12). The leg supports 402, 404 can include any of the features and/or functionalities described with respect to any of the other leg supports described herein, for example, the leg support 102. In some aspects, each leg support 402, 404 can individually support a separate leg of the patient. For example, the leg support 402 can support a right leg of the patient and the leg support 404 can support a left leg of the patient. Providing separate leg supports 402, 404 for the patient's legs may allow a caregiver more control over the patient's position, for example, by allowing the caregiver to adjust the position of each of the patient's legs individually.

In some aspects, the pivots (e.g., joints) 412, 414 of the arms 406, 408 permit pivotable movement of the arms 406, 408 about multiple axes (e.g., two axes). For example, the pivots 412, 414 can permit pivotable movement of the arms 406, 408 about second pivot axes which can extend traverse to the first pivot axes of the arms 406, 408 and/or the longitudinal axis of the bed 10. In some aspects, the second pivot axes of the arms 406, 408 can extend parallel to the support member 410 (e.g., the longitudinal axis thereof). The arms 406, 408 can pivot about the respective second pivot axis in response to a force being applied to the respective leg support 402, 404. For example, the arms 406, 408 can pivot about their respective second pivot axis in response to a patient's leg being placed on the respective leg support 402, 404. As the patient and/or caregiver moves the patient's legs, the arms 406, 408 and leg supports 402, 404 can pivot about the respective second pivot axis to accommodate said movement.

FIG. 9 illustrates a perspective view of an engagement assembly 560 which can include any of the features and/or functionalities described with respect to any of the other engagement assemblies described herein. The engagement assembly 560 can be utilized in any of the lifting devices disclosed herein. The engagement assembly 560 can include a position retention mechanism 564 which can inhibit or prevent any of the lifting devices disclosed herein from inadvertently transitioning between the stowed and deployed positions, preventing potential patient and/or operator injury. For example, the position retention mechanism 564 can inhibit or prevent the actuator support 110 from inadvertently moving (e.g., pivoting) between the stowed and deployed positions. The position retention mechanism 564 may physically block pivotable movement of the actuator support 110 between the stowed and deployed positions via contact with the actuator support 110.

The position retention mechanism 564 can include an arm 572 and a stop 566. The arm 572 can extend (e.g., upward) from the frame 242 (e.g., a top portion of the frame 242). The arm 572 can position the stop 566 in a path of pivotable movement of the actuator support 110 (e.g., along a plane of pivotable movement of the actuator support 110). For example, at least a portion of the arm 572 can extend lateral to the frame 242. In some aspects, the arm 572 can be L-shaped. The stop 566 can physically contact the actuator support 110 when the actuator support 110 begins pivoting away from the stowed or deployed position toward the other of stowed or deployed positions to inhibit or prevent the actuator support 110 from transitioning positions. The stop 566 can include a first contact surface 568 and/or a second contact surface 570. The first contact surface 568 can contact the actuator support 110 to inhibit or prevent further pivotable movement when the actuator support 110 pivots from the stowed position toward the deployed position. The second contact surface 570 can contact the actuator support 110 to inhibit or prevent further pivotable movement when the actuator support 110 pivots from the deployed position toward the stowed position. In some aspects, the contact surfaces 568, 570 can be angled (e.g., chamfered) surfaces (as shown, for example, in FIG. 9). This may enable the actuator support 110 to exert a lateral (e.g., inward) force on the stop 566 (and thus the arm 572) when the actuator support 110 is moved into contact with the stop 566.

The lifting device (e.g., the actuator support 110) can be transitioned between the stowed and deployed positions by application of a force to the actuator support 110 (e.g., in the direction of desired pivotable movement) that exceeds a threshold retention force. This force can be applied directly by a caregiver or by an actuator, e.g., the actuator 250, a motor or other mechanized device. The actuator support 110 can be moved past the stop 566 to transition between the stowed and deployed positions in response to the threshold retention force being exceeded. In some aspects, when a threshold-exceeding force is applied to the actuator support 110, the actuator support 110 can move (e.g., push) the stop 566 (e.g., laterally, inward) out of the path of movement of the actuator support 110. For example, the actuator support 110 can exert a lateral force on the stop 566 via the respective contact surface 568, 570 to move the stop 566. The arm 572 can bend (e.g., inward) in response to the actuator support 110 exerting a lateral force on the stop 566.

In some aspects, the lifting device can include a biasing member (e.g., torsion spring, gas spring) 592 and/or a damper 590. The biasing member 592 and/or the damper 590 can be disposed around the pivot 164. The biasing member 592 can bias the actuator support 110 toward the deployed position. For example, the biasing member 592 can exert a biasing force in the first rotational direction (e.g., counterclockwise in the view of FIG. 9). This may allow a caregiver to more easily transition the lifting device (e.g., the actuator support 110) to the deployed position (e.g., upward against the force of gravity). In some aspects, the biasing member 592 can oppose transitioning (e.g., pivoting) the actuator support 110 toward the stowed position (e.g., by exerting a biasing force in the first rotational direction). In such aspects, gravity can assist the caregiver in moving (e.g., pivoting) the actuator support 110 downward toward the stowed position. The damper 590 can assist in absorbing vibrations as the actuator support 110 is pivoted between the stowed and deployed positions.

In some aspects, when the threshold-exceeding force is applied, the actuator support 110 can move (e.g., laterally, outward) such that the stop 566 no longer lies in the path of pivotable movement of the actuator support 110. For example, the actuator support 110 can move along the respective angled contact surface 568, 570 away from the stop 566 such that the stop 566 no longer inhibits or prevents pivotable movement of the actuator support 110. In such aspects, the biasing member 592 can exert a lateral biasing force on the actuator support 110. For example, the biasing member 592 can pull the actuator support 110 inward toward the stop 566. When the caregiver exerts the threshold-exceeding force on the actuator support 110, the lateral biasing force of the biasing member 592 can be overcome (e.g., due to the angled contact surface 568, 570 pushing the actuator support 110 in a direction opposite the lateral biasing force of the biasing member 592). The actuator support 110 can then move laterally away from the stop 566 to permit transitioning between the stowed and deployed positions.

FIG. 10A illustrates a perspective view of a portion of the actuator support 110 of a leg lifting device (e.g., any of the leg lifting devices disclosed herein) maintained in the stowed position by a position retention mechanism 630 (which may also be referred to herein as a position lock). FIG. 10B illustrates a perspective view of a portion of the actuator support 110 maintained in the deployed position by the position retention mechanism 630. The position retention mechanism 630 can be included in any of the leg lifting devices disclosed herein. The position retention mechanism 630 can include any of the features and/or functionalities described with respect to any of the other position retention mechanisms described herein. For example, the position retention mechanism 630 can inhibit or prevent the actuator support 110 from inadvertently moving (e.g., pivoting) between the stowed and deployed positions.

The position retention mechanism 630 can include a body (e.g., guide) 631 positioning two recesses (e.g., notches) 634, 636, a locking member (e.g., key) 632, and/or a release actuator (e.g., button, knob, lever, winch) 640. The locking member 632 can be coupled to the actuator support 110 such that the locking member 632 moves (e.g., pivots) with the actuator support 110. For example, the locking member 632 can couple to a proximal (e.g., coupled) end of the actuator support 110. The locking member 632 can be shaped and/or sized to be removably received in the recesses 634, 636. The locking member 632 can selectively inhibit or prevent the actuator support 110 from inadvertently transitioning (e.g., pivoting) between the stowed and deployed positions. For example, pivotable movement of the locking member 632 (e.g., about the pivot axis of the actuator support 110) can be inhibited or prevented when the locking member is received in one of the recesses 634, 636. This may inhibit or prevent pivotable movement of the actuator support 110 between the stowed and deployed positions.

The locking member 632 can be positioned at least partially within the recess 634 when the actuator support 110 is in the stowed position. When received in the recess 634, pivotable movement of the locking member 632 (and thus the actuator support 110) away from the stowed position (e.g., toward the deployed position) can be inhibited or prevented, for example, due to contact with walls of the recess 634. The locking member 632 can be positioned at least partially within the recess 636 when the actuator support 110 is in the deployed position. When received in the recess 636, pivotable movement of the locking member 632 (and thus the actuator support 110) away from the deployed position (e.g., toward the stowed position) can be inhibited or prevented, for example, due to contact with walls of the recess 636.

The recesses 634, 636 can be positioned at opposite ends of the body 631. As shown in FIGS. 10A & 10B, the body 631 can be arcuate in shape such that the recesses 634, 636 are offset angularly from each other. The angular offset between the recesses 634, 636 can control and/or equal the angular range of motion of the actuator support 110 between the stowed and deployed positions. In some aspects, the recess 634 can be offset from the recess 636 by 90 degrees or approximately 90 degrees, for example, between 45 degrees and 135 degrees, between 60 degrees and 120 degrees, between 70 degrees and 110 degrees, between 80 degrees and 100 degrees, or any value or range within or bounded by any of these values or ranges. In some aspects, the angular position of the recesses 634, 636 can control and/or equal the angular position of the actuator support 110 when in the stowed and deployed positions, respectively. For example, the recess 634 can extend parallel or substantially parallel to horizontal and/or the longitudinal axis of the bed 10. In some aspects, the recess 636 can extend at an angle of 20 degrees or approximately 20 degrees relative to vertical, for example, between 0 degrees and 45 degrees, between 5 degrees and 35 degrees, between 10 degrees and 30 degrees, between 15 degrees and 25 degrees, or any value or range within or bounded by any of these values or ranges.

The locking member 632 can be removed from the recesses 634, 636 to permit pivotable movement of the actuator support 110. In some aspects, the locking member 632 can be removed from the recesses 634, 636 via user interaction with the release actuator 640. For example, a user can interact with (e.g., engage) the release actuator 640 to move (e.g., pivot) the locking member 632 away from (e.g., out of) the respective recess 634, 636. The release actuator 640 can operatively couple to the locking member 632, for example, via a cable 638. The cable 638 can extend between the release actuator 640 and the locking member 632. The cable 638 can be tensioned in response to user interaction with the release actuator 640. The cable 638 can couple to the locking member 632 such that the locking member 632 pivots away from (e.g., out of) the respective recess 634, 636 when the cable 638 is tensioned. In some aspects, the cable 638 can be de-tensioned (e.g., released) in response to a user disengaging (e.g., releasing) the release actuator 640 such that the locking member 632 can move (e.g., pivot) back toward the respective recess 634, 636 to retain the actuator support 110 in the stowed or deployed position. In other aspects, the user may manually move (e.g., pivot) the locking member 632 back toward the respective recess 634, 636 when the user wishes to retain the actuator support 110 in the stowed or deployed position.

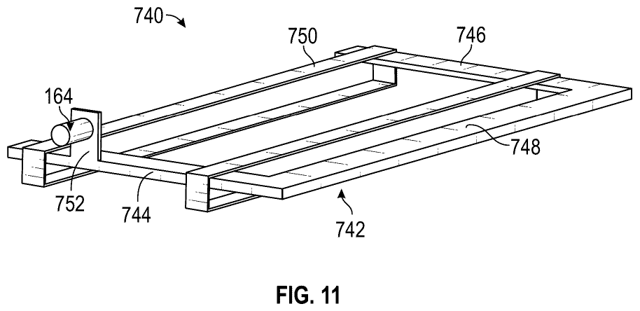

FIG. 11 illustrates a perspective view of an engagement assembly 740 for coupling a leg lifting device (e.g., any of the leg lifting devices disclosed herein) to a bed. The engagement assembly 740 can include any of the features and/or functionalities described with respect to any of the other engagement assemblies described herein. The engagement assembly 740 can include a frame 742 and one or more straps 750. The straps 750 can couple the frame 742 to a bed (e.g., the bed 10). For example, the straps 750 can couple the frame 742 to a mattress, box spring, bed frame (e.g., the bed frame 16), and/or struts of the bed. The straps 750 can extend across a width of the frame 742. The straps 750 can surround the frame 742 and one or more components of the bed. The frame 742 can couple (e.g., pivotably) to a leg lifting device (e.g., the actuator support 110 thereof) to couple the leg lifting device to the bed. For example, the actuator support 110 can couple to the frame 742 via the pivot (e.g., joint) 164.

The frame 742 can include a first arm 744, a second arm 746, and a support member (e.g., cross beam) 748 which can include any of the features and/or functionalities described with respect to any of the other support members described herein. The first arm 744 can be positioned proximate a first lateral side of the bed frame and the second arm 746 can be positioned proximate a second lateral side of the bed frame. In some aspects, the arms 744 can be supported by (e.g., positioned at least partially on top of) the respective lateral sides of the bed frame. The support member 748 can couple (e.g., extend between) the arms 744, 746. In some aspects, the first arm 744, the second arm 746, and/or the support member 748 can be positioned between the bed frame and the mattress which may help maintain a position of the frame 742 relative to the bed. The first arm 744 can include a leg 752 that positions the pivot 164.

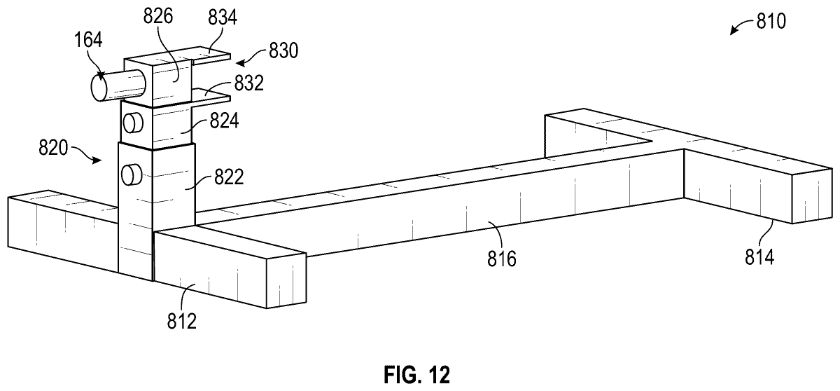

FIG. 12 illustrates a support assembly 810 for use with a leg lifting device (e.g., any of the leg lifting devices disclosed herein). The support assembly 810 can pivotably couple to the actuator support 110 via the pivot (e.g., joint) 164. The support assembly 810 can couple the leg lifting device (e.g., the actuator support 110) to a bed (e.g., bed frame) while simultaneously contacting a ground surface upon which the bed rests to provide additional support and/or stability for the leg lifting device. The support assembly 810 can include a first arm 812, a second arm 814, and a support member (e.g., cross beam) 816 which can include any of the features and/or functionalities described with respect to any of the other support members described herein. The arms 812, 814 and/or the support member 816 can be positioned below the bed (e.g., below the bed frame). The arms 812, 814 and/or the support member 816 can contact the ground surface to support the leg lifting device. The first and second arms 812, 814 can extend parallel to a longitudinal axis of the bed. The first arm 812 can be positioned proximate (e.g., below) a first lateral side of the bed while the second arm 814 can be positioned proximate (e.g., below) a second lateral side of the bed opposite the first side. The support member 816 can couple (e.g., extend between) the arms 812, 814. In some aspects, the arms 812, 814 and the support member 816 can form an I or C shape.

The support assembly 810 can include an engagement assembly 820 which can include any of the features and/or functionalities described with respect to any of the engagement assemblies described herein. For example, the engagement assembly 820 can couple the leg lifting device (e.g., the actuator support 110) to the bed (e.g., the bed frame). The engagement assembly 820 can couple to (e.g., extend from) the first arm 812 such that the engagement assembly 820 is positioned adjacent a lateral side of the bed. In some aspects, the engagement assembly 820 can include a plurality of telescoping members (e.g., beams, shafts) 822, 824, and/or 826 such that a height of the engagement assembly 820 can be adjusted to accommodate beds of different heights and/or shapes.

The engagement assembly 820 can include a clamp mechanism 830 to couple to the bed (e.g., the bed frame). The clamp mechanism 830 can include a first (e.g., lower) jaw 832 and a second (e.g., upper) jaw 834. The jaws 832, 834 can be coupled to separate telescoping members 824, 826 such that the jaws 832, 834 can move (e.g., vertically) relative to each other. For example, the first jaw 832 can couple to the telescoping member 824 and the second jaw 834 can couple to the telescoping member 826. This may enable the jaws 832, 834 to couple to (e.g., clamp) and decouple from (e.g., unclamp) bed frames of different sizes (e.g., heights) by moving the telescoping members 824, 826 (e.g., vertically) relative to each other. For example, the engagement assembly 820 can be extended (e.g., by moving the telescoping members 824 and/or 826 upward) until the first jaw 832 is positioned adjacent or contacts a bottom surface of a bed frame. Then, the telescoping member 826 can be moved vertically (e.g., upward and/or downward) until the second jaw 834 is positioned adjacent or contacts a top surface of the bed frame. The height of the telescoping members 824, 826 can be adjusted to clamp the bed frame between the jaws 832, 834.

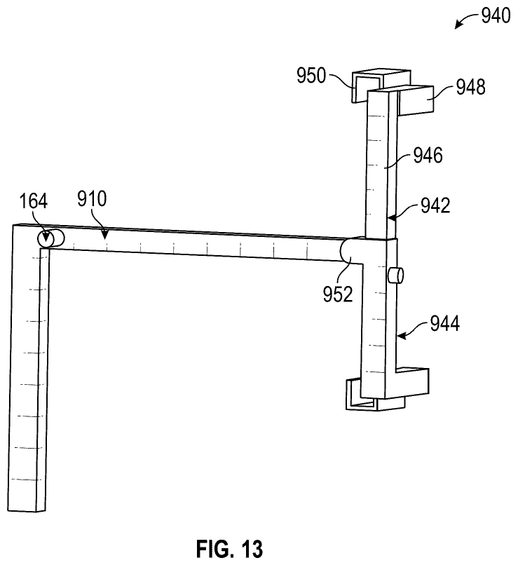

FIG. 13 illustrates a perspective view of an engagement assembly 940 and a support member 910 for use with a leg lifting device (e.g., any of the leg lifting devices disclosed herein). The engagement assembly 940 can include any of the features and/or functionalities described with respect to any of the other engagement assemblies described herein. For example, the engagement assembly 940 can couple the leg lifting device (e.g., the actuator support 110 thereof) to a bed (e.g., the bed 10). In some aspects, the engagement assembly 940 can couple the leg lifting device to a footboard of the bed (e.g., footboard 14). The support member 910 can contact a ground surface upon which the bed rests to provide additional support and/or stability for the leg lifting device.

In some aspects, the engagement assembly 940 can include a first member (e.g., beam) 942 and a second member (e.g., beam) 944 extending in series (e.g., vertically). At least a portion of the members 942, 944 can be positioned distal to the footboard. The members 942, 944 can be L-shaped. The members 942, 944 can include a first portion 946 extending vertically (e.g., lateral to the footboard) and a second portion 948 extending horizontally (e.g., toward a lateral midpoint of the footboard). The first and second portions 946, 948 can be positioned distal to the footboard. The members 942, 944 can include a coupling mechanism 950 to couple with the footboard. The coupling mechanism 950 can couple to (e.g., extend proximally from) the second portion 948. In some aspects, the coupling mechanism 950 can include one or more brackets, fasteners, clamps, or any other appropriate mechanism for coupling to the footboard. As shown in FIG. 13, in some aspects, the coupling mechanism 950 can include oppositely oriented brackets. For example, the member 942 can include a bracket that opens downward to receive a top end of the footboard, and the member 944 can include a bracket that opens upward to receive a bottom end of the footboard. In some aspects, the members 942, 944 can be telescoping such that a distance between the coupling mechanisms 950 can be adjusted to accommodate footboards of different heights and/or positions.

The engagement assembly 940 can couple to the support member 910. In some aspects, the engagement assembly 940 can couple to the support member 910 at a pivot (e.g., joint) 952 such that the engagement assembly 940 and support member 910 can pivot relative to each other. This may allow the support member 910 to pivot relative to the engagement assembly 940 to contact the ground surface. For example, the support member 910 can pivot upward or downward relative to the engagement assembly 940 depending on the height of the engagement assembly 940 relative to the ground surface. The support member 910 can pivotably couple to the actuator support 110 via the pivot (e.g., joint) 164. The support member 910 can be L-shaped.

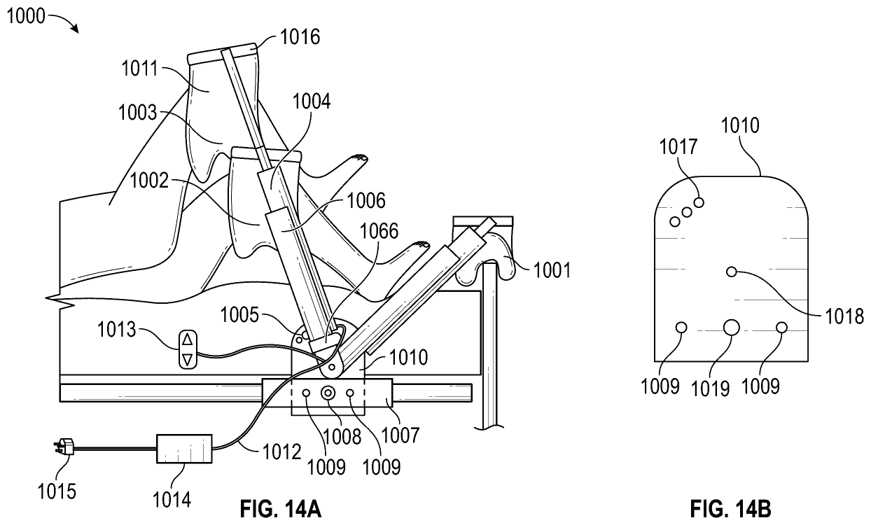

FIG. 14A shows a side view of a leg lifting device 1000 which can include any of the features and/or functionalities described with respect to any of the other leg lifting devices disclosed herein. FIG. 14B shows a side view of an actuator base 1010 of the lifting device 1000. The device 1000 attaches to a bed (e.g., the frame). The device 1000 has a leg lifting feature (which can include straps 1011, leg support beam 1025, etc.). Said leg lifting feature has a starting point 1001 (which may also be referred to herein as a stowed position), rotates and/or moves to an engagement point 1002 (which may also be referred to herein as a deployed position), and then moves to a lifted point 1003 (which may also be referred to herein as an extended position). FIG. 14A illustrates the device 1000 at the three points 1001, 1002, 1003 overlayed. The device 1000 can be operated to lift the patient's legs by engaging with the patient's legs. For example, the patient's legs can be lifted as the device 1000 moves from engagement point 1002 to lifted point 1003.

To move the device 1000 from engagement point 1002 to lifted point 1003, a (e.g., linear) actuator 1004 can be utilized. The actuator 1004 is set at an angle by angle pin 1005, which can be set in various (e.g., angularly spaced) holes 1017 if a more comfortable angle is required by the caregiver. An actuator support 1006 can be added to provide support to the device 1000. A clip 1066 can provide a fit that prevents the device 1000 from rotating back to the foot of the bed (to starting point 1001). For example, the clip 1066 can couple the device 1000 to the actuator base 1010 to inhibit or prevent rotation. A frame engagement member 1007 (which may also be referred to herein as an engagement assembly) can be added to engage (e.g., couple) the device 1000 with the frame of the bed. FIG. 14A shows an engagement knob 1008 that can be screwed onto the actuator base 1010 through a base hole 1019. The actuator base 1010 contains two engagement pins 1009 that that can maintain an orientation between the actuator base 1010 and the engagement member 1007. The number of and/or orientation of the engagement pins 1009 is exemplary. The point at which the device 1000 rotates is shown at rotation point 1018. The straps 1011 can engage with the patient's legs, for example, underneath the patient's knees. Strap supports 1016 can be added to orient the straps 1011 correctly (e.g., parallel to a longitudinal axis of the bed). The device 1000 can be controlled electronically by an actuator switch 1013, power cords 1012, power supply transformer 1014, and a plug 1015.

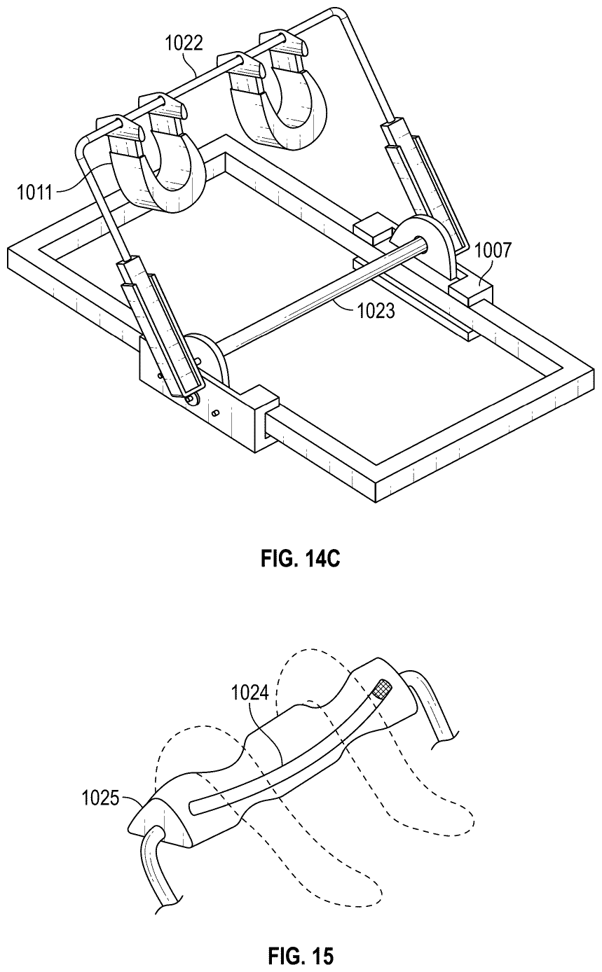

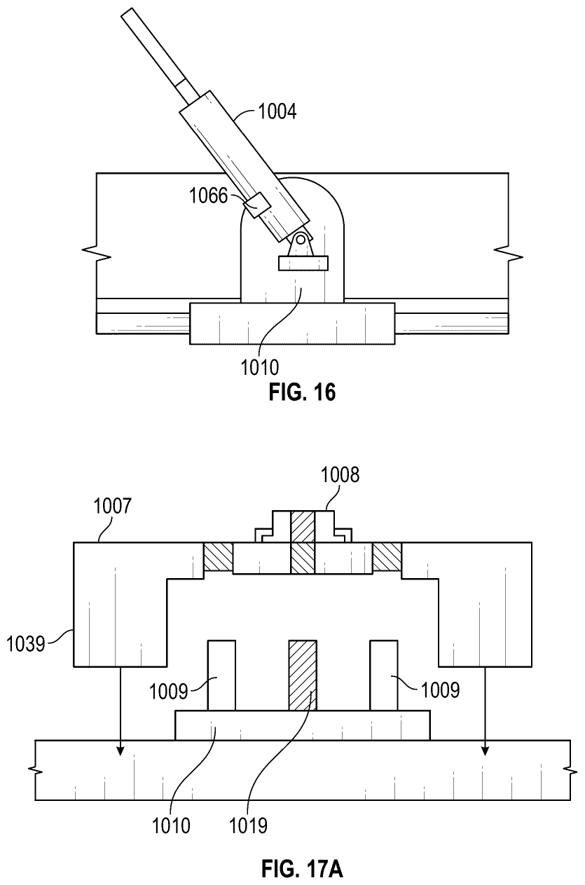

FIG. 14C shows a perspective view of the device 1000. The straps 1011 are shown hanging from a strap beam 1022, with a cross beam 1023 shown. In some aspects, the strap beam 1022 is replaced with a leg support beam 1025, as shown, for example, in FIG. 15. Leg strap 1024 can be added to hold the legs in place (e.g., against the leg support beam 1025). FIG. 16 shows portions of the device 1000 in the deployed position.

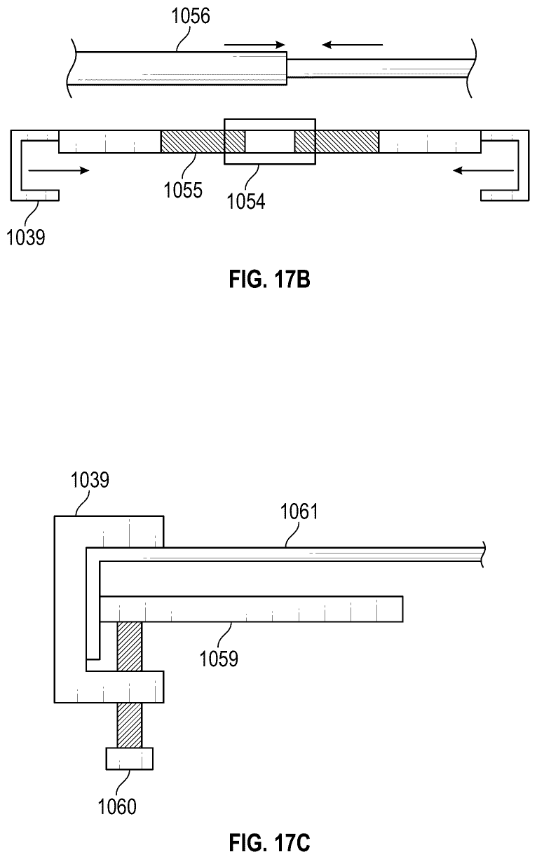

FIGS. 17A-17C shows different mechanisms for fastening the device 1000 to the bedframe. FIG. 17A shows a top view of the frame engagement member 1007. The frame engagement member 1007 can include a gripping jaw 1039 (which may also be referred to herein as a movable jaw) which can link (e.g., couple) the bedframe to the device 1000. FIG. 17B shows a tightening mechanism which tightens the gripping jaws 1039, for example, with a threaded cross beam 1055 and a threaded tightening cylinder 1054. The threaded cross beam 1055 contains a right and left side which are linked by the threaded tightening cylinder 1054. In some aspects, only one side of the threaded cross beam 1055 is threaded to bring the gripping jaws 1039 together. When the gripping jaws 1039 move together, a telescopic strap beam 1056 follows them and gets shorter. The telescopic strap beam 1056 is exemplary, and can get shorter by other means (e.g. articulating arms, via a beam that moves through a hole on one side of the bed, etc.). FIG. 17C shows a modified gripping jaw 1059, which may grip on to sheet metal bed frames 1061 or bedframes of different geometries. For example, a set screw 1060 can lift modified gripping jaw 1059 until the modified gripping jaw 1059 is tightly engaged with the frame of the bed. The modified gripping jaw 1059 mechanism is exemplary and can be achieved by other means (e.g. an articulating jaw that can conform to the bedframe).

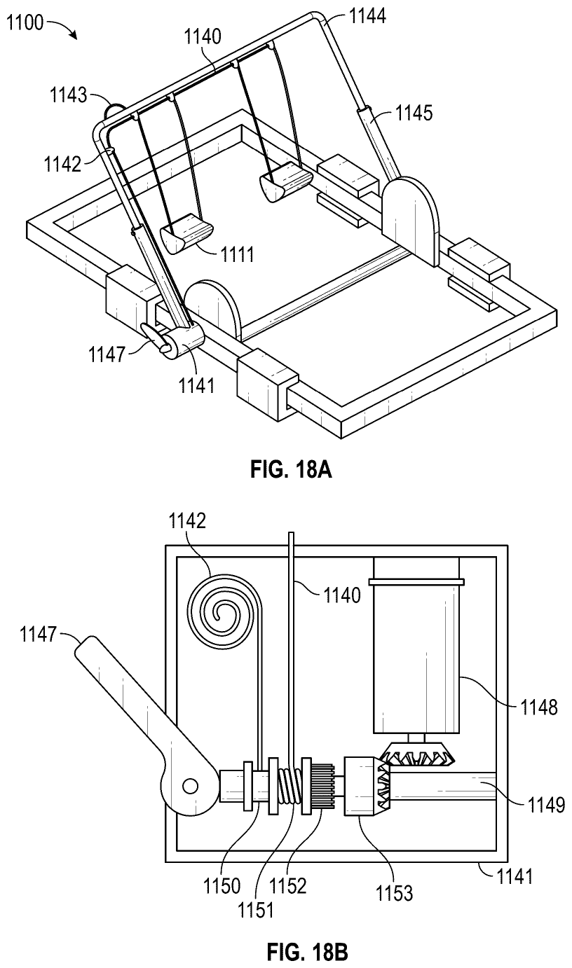

FIG. 18A shows a lifting device 1100 which can include any of the features and/or functionalities described with respect to any of the other lifting devices described herein. FIG. 18B illustrates a cross-sectional view of a motor box 1141. The strap beam 1122 or leg support beam 1025 of the lifting device 1000 can be replaced by a locking strap frame 1144. The locking strap frame 1144 can be locked into a required height. A strap pulley cable 1140 can be pulled to move the leg straps 1111 upward towards the locked locking strap frame 1144 to move the leg straps 1111 from engagement point 1002 to lifted point 1003.

The locking strap frame 1144 can extend or bend outwards. When the device 1100 is in the starting position 1001, it may be preferable for the device 1100 to be a shorter than when the device 1100 is at the engagement point 1002 and/or lifted point 1003. The locking strap frame 1144 extends outward from telescoping cylinders 1145 but may extend outward via other means (e.g. articulating arms). To move the locking strap frame 1144 outwards, the unlock switch 1143 can be pressed. Pressing the unlock switch 1143 pulls locking cables to unlock the locking strap frame 1144 from the telescoping cylinders 1145 (e.g., allowing movement of the locking strap frame 1144 relative to the telescoping cylinders 1145). Once the locking strap frame 1144 is in the correct position, the straps 1111 can be pulled down to the engaging point 1102 to engage with the patient's legs, for example, by positioning the straps 1111 under and/or around the patient's knees. The strap pulley cable 1140 can be spring loaded by the spring 1142, allowing the strap pulley cable 1140 to be taut while the locking strap frame 1144 moves to position. After engagement with the patient's legs/knees, the caregiver can pull the clutch lever 1147 to push the spring reel 1150, the cable reel 1151, and the engagement spline 1152 toward the spline gear 1153 along the reel shaft 1149. Once the engagement spline 1152 engages with the spline gear 1153, the pulley cable 1140 can be driven by the cable motor 1148. Then, the patient's legs can be lifted by the cable motor 1148. The means for pulling the strap pulley cable 1140 are exemplary, and can be pulled by other means (e.g. a hand winch or a foot winch).

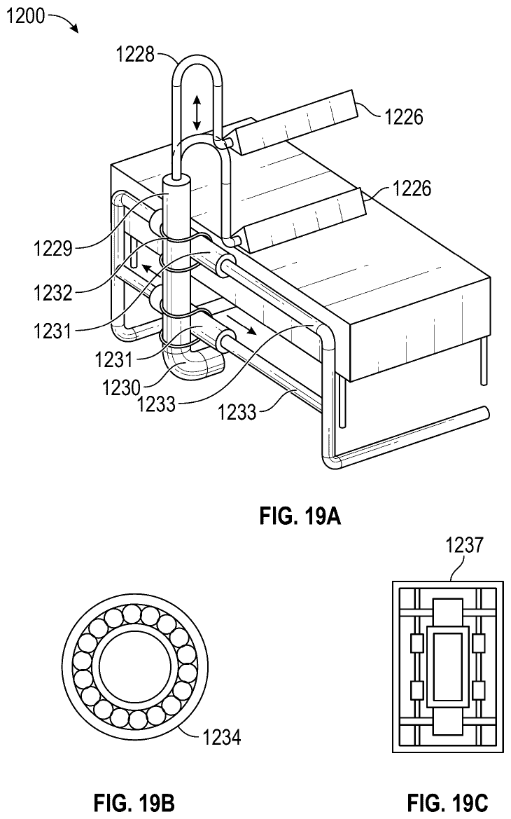

FIG. 19A shows a leg lifting device 1200 that can move along the sides of the bed. The device 1200 can include any of the features and/or functionalities described with respect to other leg lifting devices described herein. The device 1200 can include a sliding leg support beam 1226, which can be similar to the leg support beam 1025. The leg support beam 1226 can move from side to side (e.g., along a longitudinal axis of the bed). The device 1200 can include horizontal linear bearings 1231 which slide along the support frame 1233. A linear lifting shaft 1229 can lift the support rail 1228. The support rail 1228 can be attached to the sliding leg support beam 1226. The linear lifting shaft 1229 is fastened to the horizontal linear bearings 1231, for example, via a curved fastening ring 1232. The linear lifting shaft 1229 is shown housing the support rail 1228. For example, the linear lifting shaft 1229 can include one or more linear bearings 1234 (as shown, for example, by FIG. 19B) or a roller bearing mechanism 1237 (as shown, for example, by FIG. 19C). A motor mechanism 1230 allows the support rail 1228 to move up and down.

In some aspects, the device 1200 can be adapted for other purposes, such as lifting the patient out of the bed and into a wheelchair and or transportation bed. In such aspects, hooks and/or articulating members can be added to the support beam 1226, which can hoist a full body sling. When desired, the support rail 1228 may rotate, and then lower the patient out of the bed. The support frame 1233 can be modified to fit on both sides of the bed, for example, with a linear lifting shaft 1229 on each side for added strength.

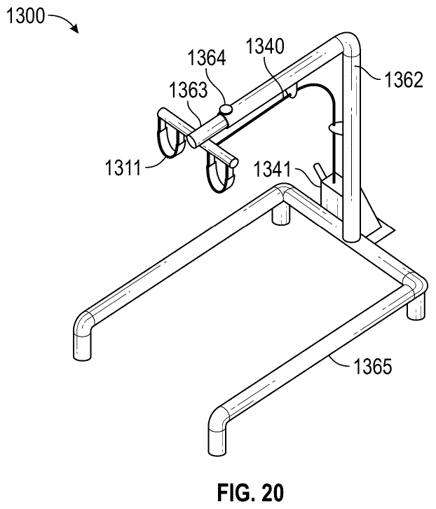

FIG. 20 shows a leg support hoist 1300 that can be placed at the head or foot of the bed. The base support structure 1365 of the leg support hoist 1300 can either rest on the ground or can be fastened to the bed. An L shaped support structure 1362 rests over the bed. The leg support hoist 1300 can include an extension arm 1363. The extension arm 1363 can be moved by pressing the extension arm release button/knob 1664. The leg support hoist 1300 contains straps 1311 (or the leg support beam 1025) that are attached to a pulley cable 1340. The pulley cable 1340 can be activated (e.g., moved) by motor box 1341. The lifting device may transfer loads to both the bed and the ground. The device can be configured to be compatible with full body slings and L shaped support structure 1362 can rotate to lift the patient out of bed. Support structure 1365 may rotate as well to provide sufficient balance.

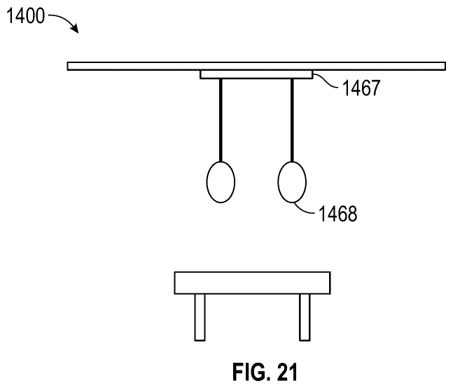

FIG. 21 shows a leg support hoist 1400 which can include a winch 1467 that is attached to the ceiling. The leg support hoist 1400 includes winch straps 1468 that can be lowered and elevated to lift the patient's legs. The winch straps 1468 may also move independently. The winch straps 1468 may include hooks to engage with a full body harness for turning purposes. The leg support hoist 1400 can be controlled wirelessly or with a remote wired to the device.

Although this disclosure has been described in the context of certain embodiments and examples, it will be understood by those skilled in the art that the disclosure extends beyond the specifically disclosed embodiments to other alternative embodiments and/or uses and obvious modifications and equivalents thereof. In addition, while several variations of the embodiments of the disclosure have been shown and described in detail, other modifications, which are within the scope of this disclosure, will be readily apparent to those of skill in the art. It is also contemplated that various combinations or sub-combinations of the specific features and aspects of the embodiments may be made and still fall within the scope of the disclosure. For example, features described above in connection with one embodiment can be used with a different embodiment described herein and the combination still fall within the scope of the disclosure. It should be understood that various features and aspects of the disclosed embodiments can be combined with, or substituted for, one another in order to form varying modes of the embodiments of the disclosure. Thus, it is intended that the scope of the disclosure herein should not be limited by the particular embodiments described above. Accordingly, unless otherwise stated, or unless clearly incompatible, each embodiment of this invention may comprise, additional to its essential features described herein, one or more features as described herein from each other embodiment of the invention disclosed herein.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, 0.1 degree, or otherwise.

Many other variations than those described herein will be apparent from this disclosure. For example, certain acts, events, or functions of any of the algorithms described herein can be performed in a different sequence, can be added, merged, or left out altogether (for example, not all described acts or events are necessary for the practice of the algorithms). Moreover, acts or events can be performed concurrently, for example, through multi-threaded processing, interrupt processing, or multiple processors or processor cores or on other parallel architectures, rather than sequentially. In addition, different tasks or processes can be performed by different machines and/or computing systems that can function together.

It is to be understood that not necessarily all such advantages can be achieved in accordance with any particular example of the examples disclosed herein. Thus, the examples disclosed herein can be embodied or carried out in a manner that achieves or optimizes one advantage or group of advantages as taught herein without necessarily achieving other advantages as may be taught or suggested herein.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A lifting device for raising legs of a patient, the lifting device comprising:
a leg support;
an actuator support coupled to the leg support at a first end of the leg support, a second end of the leg support being disposed opposite the first end;
a support member configured to extend transverse to a longitudinal axis of a mattress of a bed, the actuator support being coupled to the support member; and
one or more engagement members coupled to the support member, the one or more engagement members configured to couple to a bed to couple the lifting device to the bed;
wherein the leg support, the actuator support, and the support member form a structure configured to support one or more legs of the patient over the bed; and
wherein the actuator support is movable in a first direction to transition the lifting device from a stowed position to a deployed position and the actuator support is movable in a second direction opposite the first direction to transition the lifting device from the deployed position to the stowed position, wherein the leg support is spaced at higher elevation above the bed in the deployed position.

2. The lifting device of claim 1, wherein the second end of the leg support is a free end and the leg support, the actuator support, and the support member form a C-shaped structure.

3. The lifting device of claim 1, wherein the lifting device is configured to be removably coupled to a bed frame of the bed.

4. The lifting device of claim 3, further comprising a first clamp disposed at a first end of the support member, the first clamp configured to removably couple to the bed frame.

5. The lifting device of claim 4, further comprising a second clamp disposed at a second end of the support member opposite the first end, the first and second clamps configured to removably couple to opposite sides of the bed frame.

6. The lifting device of claim 4, wherein the first clamp comprises a clamp frame and a movable jaw configured to clamp a portion of the bed frame between the clamp frame and the movable jaw, wherein the movable jaw is repositionable relative to the clamp frame to adjust a position of the movable jaw relative to the bed frame.

7. The lifting device of claim 1, further comprising a linear actuator configured to move the leg support between a retracted position and an extended position, wherein a height of the leg support in the extended position is greater than a height of the leg support in the retracted position.

8. The lifting device of claim 1, wherein the actuator support is pivotably coupled to the support member, the actuator support configured to pivot between the stowed position and the deployed position.

9. The lifting device of claim 8, further comprising a pivot stop configured to couple to a frame of the bed to limit pivotable movement of the actuator support in the first direction.

10. The lifting device of claim 9, wherein the pivot stop is configured to prevent pivotable movement of the actuator support beyond thirty degrees relative to vertical.

11. A bed support system for a lifting device, comprising:
a support member comprising an elongate body have a first end configured to be disposed on a first side of a bed and a second end configured to be disposed on a second side of the bed opposite to the first side of the bed;
a first bed engagement member having a first portion configured to couple with a bed on the first side of the bed and a second portion configured to couple with the first end of the support member;
a second bed engagement member having a first portion configured to couple with a bed on the second side of the bed and a second portion configured to couple with the second end of the support member; and
an angle control structure coupled with the first bed engagement member, the angle control structure configured to limit movement of an actuator support to define one or more of a position and an angle of a leg support beam relative to vertical.

12. The bed support system of claim 11, wherein the angle control structure comprises a plate member having an upright planar portion configured to be inclined at an angle between 5 and 30 degrees from vertical when the bed support system is mounted to the bed.

13. A lifting device comprising:
the bed support system of claim 12;
an actuator support pivotably coupled with the first bed engagement member adjacent to a first end and extending away from the first end to a second end; and
a leg support beam having a first end coupled with the second end of the actuator support and a second end opposite to the first end;
wherein a first contact surface of the actuator support is supported by the plate member when the actuator support is in a deployed position.

14. The lifting device of claim 13, wherein the leg support beam is cantilevered by the actuator support such that the leg support beam has a free end and an unobstructed access path to or from the bed is provided under the leg support beam when the actuator support is in the deployed position.

15. The lifting device of claim 13, further comprising a linear actuator coupled with the actuator support to drive the leg support beam between an elevated position and a lowered position.

16. The bed support system of claim 11, wherein one or both of the first bed engagement member and the second bed engagement member comprises a clamp comprising a fixed jaw and a movable jaw, the movable jaw being translatable relative to the fixed jaw to allow clamping over a length, a width, or a height of the bed.

17. The bed support system of claim 16, wherein the movable jaw is supported in a slotted plate disposed opposite to the fixed jaw.

18. A lifting device for raising legs of a patient, the lifting device comprising:
one or more leg supports for receiving the legs of a patient;
an actuator support pivotably coupled to the one or more leg supports;
a support member configured to extend transverse to a longitudinal axis of a mattress of a bed, the actuator support being movably coupled to the support member; and
one or more engagement members coupled to the support member, the one or more engagement members configured to couple to a bed to couple the lifting device to the bed;
wherein the one or more leg supports, the actuator support, and the support member form a structure configured to support one or more legs of the patient over the bed; and
wherein the one or more leg supports are configured to pivot toward the actuator support to transition the lifting device to a stowed position, and the one or more leg supports are configured to pivot away from the actuator support to transition the lifting device to a deployed position, wherein the one or more leg supports are positioned over the bed in the deployed position and a footprint of the lifting device is smaller in the stowed position than in the deployed position.

19. The lifting device of claim 18, wherein the one or more leg supports comprise a first leg support and a second leg support, the first and second leg supports coupled to separate arms configured to suspend the first and second leg supports over the bed when in the deployed position.

20. The lifting device of claim 19, wherein the arms are configured to pivot about multiple axes, the leg supports configured to pivot with the respective arm.
